(19) United States
(12) Patent Application Publication
(10) Pub. No.: US 2018/0361663 A1
(43) Pub. Date: Dec. 20, 2018

(54) A Three Dimensional Printing Apparatus, a Material Dispensing Unit Therefor and a Method

(71) Applicant: Maximilian Barclay Burt, Aberdeen (GB)

(72) Inventor: Maximilian Barclay Burt, Aberdeen (GB)

(21) Appl. No.: 15/740,960

(22) PCT Filed: Jul. 1, 2016
(86) PCT No.: PCT/GB2016/052015

§ 371 Date: Dec. 29, 2017

(30) Foreign Application Priority Data
Jul. 3, 2015 (GB) 1511735.1
Oct. 30, 2015 (GB) 1519227.1

(51) Int. Cl. B29C 64/209; B29C 64/153; B29C 64/393; B33Y 10/00; B33Y 30/00; B33Y 50/02

(52) U.S. Cl. CPC B29C 64/209; B29C 64/153; B33Y 50/02; B33Y 10/00; B33Y 30/00; B29C 64/393

(57) ABSTRACT

A material dispensing unit (1; 10) for a three dimensional printing apparatus (100; 200) has a nozzle (3) for depositing particulate material (5; 220a, 220b; 224; 226) on a build surface (7), where the nozzle defines a through passage (9) for the material. The through passage has an inlet end (11) for receiving the material and an outlet end (15) for dispensing the material. A valve (21) is provided at least one of at, within or in fluid communication with the through passage for controlling flow of the material via the through passage, the valve being operable between open and closed positions. Flow of said material into the through passage is blocked when in the closed position and, when in the open position, flow of the material into the through passage is allowed. A method of forming a three dimensional object (31) is also disclosed, as is a three dimensional printing apparatus (200) comprising one or more dispensing units (la; b) for dispensing particulate material (220a, 220b; 224; 226), an enclosure (137) for containing the material dispensed by the one or more dispensing units and one or more heating elements (210, 212) for heating the material contained in the enclosure to a first predetermined temperature.

### FIELD OF THE INVENTION

The invention relates to a three dimensional (3D) printing apparatus (aka additive manufacturing apparatus) for forming three dimensional objects, a material dispensing unit therefor and a corresponding method of three dimensional printing.

### BACKGROUND OF THE INVENTION

3D printing is a process of making three dimensional solid objects from a digital file under computer control. The creation of a 3D printed object is achieved using additive processes by laying down successive thin layers of material until the entire object is created. A variety of 3D printing solutions exist differing mainly in the way layers are built to create the final object. Some methods produce the layers by binding powdered or granular material, others use curing soft or melted material.

Selective laser sintering (SLS) and fused deposition modelling (FDM) are the most common technologies using this way of printing.

SLS uses a tank filled with powdered or granular material and has a levelling roller that spreads the material across a build plate or platform to obtain an even spread of powder in a layer. A laser provided above the build plate then selectively heats up the material that has just been laid thereby sintering the loose material particles creating the new layer and bonding the new and the previously created layers. The unsintered material becomes a support structure for the object. The process is repeated until a solid 3D printed object is obtained which can be picked up out of the rest of the material that has not been sintered. Any unused loose material can be re-used for the next print. Disadvantages of the SLS method include the ability only to form a whole layer of the same material, the need for a roller to even out the laid powder and as a result, inaccuracies in the finished article.

FDM uses plastic filament wire wound on a drum. The wire is fed into a heating element which turns the wire into drops of melted plastic. The 3D object is produced by extruding the drops of melted plastic across the build plate to form layers as the material hardens immediately upon extrusion. Disadvantages of the FDM method lie in that it is difficult to have more than one material per layer and that support structure has to be created separately using a second filament and subsequently removed from the finished article. A further disadvantage is that when the drops of melted plastic are dragged across the build plate a clean drag is unlikely to be obtained and therefore accuracy of the finished article is likely to be compromised.

Another method of printing is called stereolithography (SLA). This method employs a vat of liquid, light curable resin and a laser to cure the resin to build the object's layers one at a time. For each layer, the laser traces the specified cross section of the object on the surface of the liquid resin. The laser light cures the traced region and joins it to the layer below. After the layer has been cured, the SLA's build platform descends by a distance equal to the thickness of a single layer and a blade sweeps across the cross section of the part, re-coating it with fresh material for a new layer. SLA requires the use of supporting structures which serve to attach the object to the build platform and to hold the object because it floats in the vessel filled with liquid resin. These need to be removed manually after the object is finished. A further disadvantage of this method is that it can only use light curable resins and cannot use other materials, for example, metals or ceramics.

A feature common to most known 3D printing is the “building” of a 3D object layer by layer. This makes the process of creating a 3D object time consuming.

The object of the present invention is to obviate and mitigate one, more than one or all of the above drawbacks.

### SUMMARY OF THE INVENTION

According to a first aspect of the present invention, there is provided a material dispensing unit for a three dimensional printing apparatus, the material dispensing unit comprising:
a nozzle for depositing particulate material on a build surface;
the nozzle defining a through passage for said material, the through passage having an inlet end for receiving said material and an outlet end for dispensing said material;
a valve provided at least one of at, within or in fluid communication with the through passage for controlling flow of said material via the through passage, the valve being operable between open and closed positions, wherein, in the closed position, flow of said material into the through passage is blocked and, in the open position, flow of said material into the through passage is allowed.

Preferably, the through passage has a width in a cross section substantially perpendicular to the direction of flow of said material through said passage. Preferably, said width is sufficient to allow only a single particle of a predetermined diameter of the particulate material to pass through the cross section widthwise at a time.

Hereinafter, for brevity, the “material dispensing unit” will be referred to as the “dispensing unit”.

Accordingly, only one particle of the predetermined diameter of the particulate material is allowed to exit the through passage widthwise and be deposited on the build surface at a time. This allows a one particle of the predetermined diameter high trail of particles to be deposited on the build surface during relative movement of the dispensing unit across the build surface with the valve open. This in turn increases accuracy of a finished printed 3D article. Preferably, in use, the speed of relative movement of the dispensing unit across the build surface is selected taking into account the predetermined diameter of the particles so that the particles of the trail are deposited on the build surface adjacent to each other and, in some instances, in abutment with each other.

Preferably, the predetermined diameter is the maximum particle diameter specified for a given batch of the particulate material. In one application of the dispensing unit of the invention, the material in a new layer which has been deposited by the material dispensing unit may be selectively sintered by a laser provided above the build surface in the three dimensional printing apparatus thereby creating solid regions in the layer and bonding the solid regions to the previously created layer.

Any unsintered material, along with the sintered regions, becomes a support structure for the subsequent layer. The process is repeated until a solid 3D printed article is obtained which can be picked up out of the rest of the material that has not been sintered. Any unused loose material, including the material in the unsintered regions and leftover material in the dispensing unit can be re-used for the next print. It will be appreciated that in the present specification, for brevity, the term “build surface”, unless otherwise specified, includes an upper surface of a build plate of the three dimensional printing apparatus as well as an upper surface of a newly created layer onto which a subsequent layer is to be deposited. Typically, the upper surface of the build plate serves as a build surface for a first layer of the article to be printed. The first layer deposited on the upper surface of the build plate is typically not sintered so that the printed article remains unattached to the build plate for ease of removal.

The width of the through passage in a cross section substantially perpendicular to the direction of flow of said material through the passage may be constant or varied along the through passage between the inlet and outlet ends as long as there is at least one cross section substantially perpendicular to the direction of flow of said material through the passage whose width is sufficient to allow only a single particle of a predetermined diameter of the particulate material to pass through the cross section widthwise at a time. Such width may be provided by the cross sectional dimension of the through passage itself or differently, for example, by obstructing the through passage by another object, such as, for example, but not limited thereto, by a relevant portion of the valve.

In one variation, the through passage has a length in the cross section of the through passage substantially perpendicular to the direction of flow of said material through the passage, the length extending substantially perpendicular to the width. In one variation, the length is sufficient to allow only a single particle of a predetermined diameter of the particulate material to pass through the cross section lengthwise at a time. In other words, said cross section of the through passage takes the form of an aperture having a width and a length, or a diameter, sufficient to allow only a single particle of a predetermined diameter of the particulate material to pass through the cross section the aperture at a time. In this variation, the trail of particles deposited on the build surface during relative movement of the dispensing unit across the build surface, with the valve open, takes the form of a line one particle high and one particle wide. In another variation, the length is sufficient to allow a predetermined number of particles of a predetermined diameter of the particulate material to pass through the cross section lengthwise at a time. In other words, the cross section of the through passage takes the form of a slit having a width sufficient to allow only a single particle of a predetermined diameter of the particulate material to pass through the cross section widthwise at a time and a length sufficient to allow a predetermined number of particles of the predetermined diameter of the particulate material to pass through the cross section lengthwise at a time. In this variation, the trail of particles deposited on the build surface during relative movement of the dispensing unit across the build surface, with the valve open, takes the form of a band one particle high and the predetermined number of particles wide in the direction across the band.

Preferably, in use, the dispensing unit is positioned in the three dimensional printing apparatus such that during deposition of the particulate material from the nozzle of said dispensing unit, the width of the cross section of the through passage is substantially parallel to the direction of relative movement of the dispensing unit across the build surface and the length of the cross section of the through passage is substantially perpendicular to the direction of relative movement of the dispensing unit across the build surface in a plane substantially parallel to the build surface.

Preferably, the nozzle includes a planar surface surrounding the outlet opening of the through passage and lying in a plane substantially perpendicular to the direction of flow of said material through the passage. Such an arrangement helps to ensure that a one particle high layer is deposited on the build surface and to hold down the already deposited particles.

Preferably, the valve comprises a body movable relative to the through passage of the nozzle between a first position in which the body blocks the through passage and the valve is closed and a second position in which the through passage is unblocked and the valve is open.

Preferably, the dispensing unit comprises a controllable actuator arrangement adapted for actuating the valve to open or close. The actuator arrangement is preferably controlled by a control unit. Preferably, the actuator arrangement is adapted for moving the valve body between the first and second positions thereby opening and closing the through passage. The actuator arrangement preferably comprises a drive unit for providing motive force for moving the valve. The control unit is preferably an electronic control unit, preferably, a programmable electronic control unit.

In one arrangement, the body comprises a through channel, wherein in the open position of the valve, the through channel is in alignment with the through passage of the nozzle, and in the closed position of the valve, the through channel is out of alignment with the through passage of the nozzle such that the body blocks the through passage. The through channel may be shaped to conform to the shape of the through passage of the nozzle. For example, if the through passage takes the form of an aperture, the through channel may also be provided as an aperture. If the through passage takes the form of a slit, the through channel may also be provided as a slit.

In one variation, the actuator arrangement comprises a cam pair comprising a cam member and a follower member wherein the follower member is linked with the valve body to move the valve body to open and close the through channel and the cam member is coupled to the follower member, such that movement of the cam member is translated into the movement of the follower member and that of the valve body. The cam member is preferably arranged to move in the dispensing unit along a first path. Preferably, the follower member is linked with the valve body to move the valve body along a second path for opening and closing the through channel. The follower member may be formed integrally with the valve body. The cam member is coupled with the follower member such that movement of the cam member along the first path is translated into the movement of the follower member and that of the valve body along the second path. The first and second paths are preferably provided at an angle to each other. The first and second paths may be provided perpendicular to each other. The cam pair may have a predetermined translation ratio, i.e. the correlation of the distance travelled by the cam member and the distance travelled by the follower member as a result. The predetermined ratio may be selected such that for a given distance travelled by the cam member the follower member travels a known smaller distance. Such an arrangement provides for a greater precision of the movement of the follower member and, as a result, the valve body. For example only, if the ratio of the cam pair is 5:1, for any 5 given units of distance travelled by the cam member the follower member travels 1 unit of distance. Other suitable ratios may be selected as necessary. In one variation, the cam member comprises a piston rod and the follower member comprises a portion of the valve body. A bore is defined in the follower member for receiving the piston rod. The bore has internal walls bevelled in relation to each of the first and second paths and the piston rod is in engagement with the bevelled walls such that during movement of the piston rod to and fro along the first path, force is applied to the bevelled walls of the bore to move the follower member respectively to and fro along the second path with the applicable translation ratio thereby moving the valve body between the open and closed positions. Preferably, the cam member is moved by the drive unit of the actuator arrangement. Other variations of the cam member and the follower member will be apparent to a person skilled in the art.

It will be appreciated that the present invention is not limited to a particular type the actuator arrangement and other types of actuator arrangement would be apparent to a person skilled in the art. For example, but not limited thereto, the actuator arrangement may be provided by a gear box, a worm box, a gear and a plank or another suitable mechanical or electromechanical actuation mechanism. The drive unit for driving the piston rod may be provided, for example, in the form of a stepper motor. An example of a suitable stepper motor is Haydon Kerk™ L15000, but other models will also be found suitable. However, it will be appreciated that the drive unit may also be provided in any suitable form apparent to a person skilled in the art, such as, for example, a different type of motor, a piezoelectric transducer, a hydraulic or pneumatic cylinder or other suitable means.

In one arrangement, the dispensing unit comprises a housing incorporating the nozzle, the housing also defining a cavity for accommodating the valve and a seat for mounting the actuator arrangement. In one arrangement, the housing comprises one or more interlocking members to be connected with one or more housings of further such dispensing units in order to form an assembly comprising a plurality of dispensing units for a three dimensional printing apparatus. Alternatively or additionally, the housing may incorporate a plurality of nozzles, a plurality of cavities for accommodating respective valves and a plurality of seats for mounting respective actuator arrangements.

Preferably, the dispensing unit comprises a delivery arrangement for delivering said material into the through passage. The delivery arrangement may be arranged in communication with a storage vessel for containing the particulate material and feeding the particulate material into the delivery arrangement. The delivery arrangement may be coupled with the storage vessel to be gravity fed from the storage vessel. Preferably, the housing incorporates the delivery arrangement. The delivery arrangement may comprise a delivery duct.

According to a second aspect of the present invention, there is provided an assembly comprising a plurality of material dispensing units for a three dimensional printing apparatus in accordance with the first aspect of the invention, wherein the units are arranged to form an array.

In one arrangement, the plurality of dispensing units are connected via one or more interlocking members of respective housings of the dispensing units in order to form the assembly.

In such an assembly, individual storage vessels may be provided for each delivery arrangement or a storage vessel may be arranged to feed a number of delivery arrangement.

In one arrangement, there is provided a first assembly (hereinafter referred to as the primary assembly for brevity) comprising a plurality of primary dispensing units for a three dimensional printing apparatus in accordance with the first aspect of the invention, wherein the units are arranged to form an array and are adapted for dispensing first particulate material. The first particulate material may comprise one or more sub-types of the first material.

In one variation, there is provided a second assembly (hereinafter referred to as the ancillary assembly for brevity) comprising a plurality of ancillary dispensing units for a three dimensional printing apparatus in accordance with the first aspect of the invention, wherein the units are arranged to form an array and are adapted for dispensing second particulate material. The second particulate material may comprise one or more sub-types of the second material.

The first and second materials may be the same or different type of material. The first and second materials may be the same colour or different colours. The first and second materials may have the same or different fineness. The first particulate material may be coarser than the second particulate material.

In one arrangement, in the primary assembly, at least some of the plurality of the primary dispensing units have the through passages that are provided as slits having a width sufficient to allow only a single particle of a predetermined diameter of the particulate material to pass through the cross section widthwise at a time and a length sufficient to allow a predetermined number of particles of the predetermined diameter of the particulate material to pass through the cross section lengthwise at a time. In one variation, the slits are uniformly oriented in the primary assembly. Preferably, the slits are positioned such that an uninterrupted band of material is deposited on the build surface from the said slits when the respective valves are open. The slits may be positioned in a single line. However, to ensure that there are no gaps between individual bands of material deposited between two adjacent slits, the slits are preferably positioned along at least two parallel lines in which the slits are arranged in a staggered manner.

In one arrangement, in the ancillary assembly, at least some of the plurality of the ancillary dispensing units have the through passages that are provided as slits having a width sufficient to allow only a single particle of a predetermined diameter of the particulate material to pass through the cross section widthwise at a time and a length sufficient to allow a predetermined number of particles of the predetermined diameter of the particulate material to pass through the cross section lengthwise at a time. In one variation, at least two of the slits are positioned rotated relative to each other in a plane substantially parallel to the build surface. The rotation between said slits is preferably 90 degrees such that a first slit can deposit a band of material when the ancillary assembly is moved in a first direction substantially perpendicular to the first slit; and the second slit can deposit a band of material when the ancillary assembly is moved in a second direction substantially perpendicular to the second slit and to the first direction. In one arrangement, in the ancillary assembly, at least some of the plurality of the ancillary dispensing units have the through passages that are provided as apertures having cross sections with a width and a length, or a diameter, sufficient to allow only a single particle of a predetermined diameter of the particulate material to pass through the cross section of the aperture at a time.

According to a third aspect of the present invention, there is provided a three dimensional printing apparatus comprising:
one or more dispensing units according to the first aspect of the invention;
a build surface for supporting the material dispensed from the one or more dispensing units;
wherein the one or more dispensing units are movably arranged to move relative to the build surface in a plane substantially parallel to the build surface.

In one arrangement, the apparatus comprises at least two dispensing units, of which a first dispensing unit is a primary dispensing unit for dispensing first particulate material and the second dispensing unit is an ancillary dispensing unit for dispensing second particulate material. The first and second materials may be the same or different type of material. The first and second materials may be the same colour or different colours. The first and second materials may have the same or different fineness. The first particulate material may be coarser than the second particulate material. The first particulate material may comprise one or more sub-types of the first material. The second particulate material may comprise one or more sub-types of the second material.

In one arrangement, the apparatus comprises one or more assemblies in accordance with the second aspect of the invention.

Preferably, the apparatus comprises a control arrangement configured for controlling the relative movement of the one or more dispensing units across the build surface. The control arrangement is preferably configured for controlling the speed of relative movement of the one or more dispensing unit across the build surface taking into account the predetermined diameter of the particles of the particulate material so that the particles are deposited on the build surface in a one particle thick trail adjacent to each other and, in some instances, in abutment with each other.

A drive arrangement, such as, for example, a motor, is preferably provided for effecting relative movement of the one or more dispensing units in relation to the build surface along an axis substantially perpendicular to the build surface. A guide structure, such as, for example, but not limited thereto, a lead screw, is preferably provided for guiding and supporting the one or more dispensing units or the build surface during their relative movement of along the axis substantially perpendicular to the build surface.

Preferably, the apparatus includes a control mechanism configured for controlling the drive arrangement so as to provide a predetermined spacing between the build surface and the outlet end of the through passage of nozzle of the dispensing unit. Preferably, the control mechanism is configured for controlling the drive arrangement so that a distance between said outlet end and the build surface is sufficient to allow only a single particle of a predetermined diameter of the particulate material to be accommodated between the outlet opening of the nozzle and the build surface in the direction substantially perpendicular to the build surface. Such an arrangement helps to ensure that a one particle high layer is deposited on the build surface and to hold down the already deposited particles. Once a new layer has been created, the dispensing unit is spaced from the new layer by the same distance.

The apparatus may be configured for sintering predetermined regions in any given layer. Unsintered regions serve as support for a subsequent layer and the unsintered material may be reused in a subsequent print.

Preferably, a suitable drive mechanism, such as, for example, a motor, is provided for moving and positioning the one or more dispensing units in the apparatus in a plane substantially parallel to the build surface.

In one arrangement, the one or more dispensing units are mounted on a carrier frame and the carrier frame is mounted on a guide structure and is moved on the guide structure with the aid of the drive mechanism. The guide structure may be arranged to move the carrier frame along a first axis substantially parallel to the build surface. The guide structure may be provided in any suitable form, such as, but not limited thereto, in the form of one or more lead screws on which the carrier frame is mounted. If the guide structure includes two or more guide screws, a synchronising mechanism is preferably provided to synchronise rotation of the lead screws. The synchronising mechanism may, for example, include a drive belt coupled to the drive mechanism or a separate drive mechanism. In the embodiment where primary and ancillary dispensing units, or as the case may be, primary and ancillary assemblies, are provided, the primary dispensing unit or the primary assembly is preferably mounted on a main carrier frame which in turn is mounted on a main guide structure and moved by a main drive unit along the first axis. The ancillary dispensing unit or the ancillary dispensing assembly is preferably mounted on an ancillary carrier frame which in turn is mounted on an ancillary guide structure and moved by an ancillary drive unit along at least a second axis. The second axis may be perpendicular to the first axis in a plane substantially parallel to the build surface. The ancillary guide structure may be mounted on the main carrier frame so that the ancillary dispensing unit or the ancillary dispensing assembly can be moved along both first and second axes. Generally, the ancillary guide structure is preferably arranged to give the ancillary carrier frame more degrees of freedom to move across the build surface than has the main carrier frame.

Typically, the apparatus includes a build plate which has an upper surface serving as a build surface for a first layer of the article to be printed. The first layer deposited on the upper surface of the build plate is typically not sintered so that the printed article remains unattached to the build plate for ease of removal.

The apparatus preferably includes a build chamber housing the build plate for containing the deposited particulate material. The build chamber preferably includes walls surrounding the build plate. The walls of the build chamber may be transparent.

In one arrangement, the apparatus may comprise a laser sintering unit configured for selective sintering of the loose particulate material in a layer deposited by the one or more dispensing units to create solid regions in the layer. Preferably, a control system is provided configured for controlling the operation of the laser sintering unit to sinter predetermined regions in the layer of the deposited material. Preferably, the control system is an electronic control system.

Preferably, the control unit for controlling the actuator arrangement of the or each dispensing unit is configured for controlling the actuator arrangement to selectively open and close the valve of the or each dispensing unit in order to deposit the particulate material onto predetermined regions of the build surface. This allows predetermined regions in a layer to be left blank. The blank regions can then be filled using the material of a different dispensing unit. For example, in the embodiment comprising primary and ancillary dispensing units or primary and ancillary assemblies, the valve in the primary dispensing unit or certain valves in the primary assembly can be left closed to leave blank regions which are then filled with the second material from the ancillary dispensing unit or one or more dispensing units of the ancillary assembly. The control unit is preferably configured for controlling the actuator arrangement to open and close the respective valve in each dispensing unit independently. Thus, a three dimensional article can be created which includes parts composed from different materials.

According to a fourth aspect of the present invention, there is provided a method of forming a three dimensional object, the method comprising the steps of:
providing a three dimensional printing apparatus in accordance with the third or fifth aspect of the invention; and
printing a three dimensional article using the three dimensional printing apparatus.

The method preferably comprises the step of controlling the valve of the one or more dispensing units to open and close and in the open position of the valve allowing only a single particle of a predetermined diameter of the particulate material to pass through the cross section of the through passage of the nozzle of the one or more dispensing units widthwise at a time.

Preferably, the method comprises controlling the actuator arrangement of the or each dispensing unit to open or close the valve.

The method preferably comprises the step of moving the one or more dispensing units relative to the build surface in plane substantially parallel to the build surface and depositing a one particle high trail of particulate material on the build surface. The method further preferably comprises the step of creating one particle high layer of particulate material of a plurality of trails of particles deposited on the build surface during relative movement of the one or more dispensing units across the build surface, each trail being laid in the form of a band one particle high and a predetermined number of particles wide in the direction across the band or a line one particle high and one particle wide.

Preferably, the method comprises controlling the speed of relative movement of the dispensing unit across the build surface taking into account the predetermined diameter of the particles of the particulate material being deposited so that the particles are deposited on the build surface adjacent to each other and, in some instances, in abutment with each other.

Preferably, the method includes controlling relative movement of the one or more dispensing units in relation to the build surface along an axis substantially perpendicular to the build surface so as to provide a predetermined spacing between the build surface and the outlet end of the through passage of nozzle of the dispensing unit. Preferably, the method includes controlling said relative movement so that a distance between said outlet end and the build surface is sufficient to allow only a single particle of a predetermined diameter of the particulate material to be accommodated between the outlet opening of the nozzle and the build surface in the direction substantially perpendicular to the build surface. Once a new layer has been created, the dispensing unit is spaced from the new layer by the same distance.

Preferably, the method comprises positioning the one or more dispensing units in the three dimensional printing apparatus such that during deposition of the particulate material from the nozzle of said dispensing unit, the width of the cross section of the through passage of the nozzle is substantially parallel to the direction of relative movement of the dispensing unit across the build surface and the length of the cross section of the through passage is substantially perpendicular to the direction of relative movement of the dispensing unit across the build surface in a plane substantially parallel to the build surface.

In one arrangement, the method comprises depositing first particulate material on the build surface using a primary dispensing unit or a primary dispensing assembly and depositing second particulate material on the build surface using an ancillary dispensing unit or an ancillary dispensing assembly. The first and second materials may be the same or different type of material. The first and second materials may be the same colour or different colours. The first and second materials may have the same or different fineness. The first particulate material may be coarser than the second particulate material.

In the embodiment where primary and ancillary dispensing units, or as the case may be, primary and ancillary assemblies, are provided, the method preferably includes moving the primary dispensing unit or the primary assembly in a plane substantially parallel to the build surface along a first axis; and moving the ancillary dispensing unit or the ancillary dispensing assembly along at least a second axis, the second axis being preferably perpendicular to the first axis in a plane substantially parallel to the build surface. The method may include moving the ancillary dispensing unit or the ancillary dispensing assembly along both first and second axes. The method may include providing the ancillary dispensing unit or the ancillary dispensing assembly with more degrees of freedom to move across the build surface than has the main carrier frame.

Preferably, the method comprises controlling the actuator arrangement of the or each dispensing unit to selectively open and close the valve of the or each dispensing unit in order to deposit the particulate material onto predetermined regions of the build surface and leaving predetermined regions in a layer blank. The method preferably comprises filling the blank regions with the material of a different dispensing unit. For example, in the embodiment comprising primary and ancillary dispensing units or primary and ancillary assemblies, the method includes leaving the valve in the primary dispensing unit or certain valves in the primary assembly closed to leave blank regions and filling the blank regions with the second material from the ancillary dispensing unit or one or more dispensing units of the ancillary assembly. The method preferably includes controlling the actuator arrangement to open and close the respective valve in each dispensing unit independently.

Where the three dimensional printing apparatus is in accordance with the third aspect of the invention, the method preferably includes selectively sintering the material in a layer which has been deposited by the one or more dispensing units, preferably, by a laser provided above the build surface in the three dimensional printing apparatus thereby creating solid regions in the layer and bonding the solid regions to the previously created layer. Preferably, the method includes controlling the operation of sintering to sinter predetermined regions in the layer of the deposited material. The method preferably includes using any unsintered material, along with the sintered regions, as a support structure for the subsequent layer. The method includes repeating the process until a solid 3D printed article is obtained which is then picked up out of the rest of the material that has not been sintered. The method preferably includes using unused loose material, including the material in the unsintered regions and leftover material in the one or more dispensing units for the next print. In the embodiment where primary and ancillary dispensing units, or as the case may be, primary and ancillary assemblies, are provided and respective first and second different materials are used for printing, the method preferably includes using the first material for the unsintered regions in a layer.

In one arrangement, the method comprises providing, at least some of the plurality of the ancillary dispensing units in the ancillary assembly with the through passages in the form of slits having a width sufficient to allow only a single particle of a predetermined diameter of the particulate material to pass through the cross section widthwise at a time and a length sufficient to allow a predetermined number of particles of the predetermined diameter of the particulate material to pass through the cross section lengthwise at a time and positioning at least two of the slits rotated relative to each other in a plane substantially parallel to the build surface. Preferably, the method includes positioning said slits rotated by 90 degrees relative to each other and depositing a band of material through a first slit whilst moving the ancillary assembly in a first direction substantially perpendicular to the first slit; and depositing a band of material through the second slit whilst moving the ancillary assembly in a second direction substantially perpendicular to the second slit and to the first direction.

The apparatus of the present invention uses valves to control the deposition of particulate material. These valves have micro-openings that can be made in any realistic length (a dimension extending perpendicular to the direction of travel of the material dispensing vessel in plan view when dispensing material) but always have a maximum open width (a dimension extending parallel to the direction of travel of the material dispensing vessel in plan view when dispensing material) equal to the predetermined particle diameter of the particulate material. This allows either a two dimensional band of loose particulate material or even a line single particle wide to be deposited as necessary. The apparatus is adjusted to control the speed of movement of the micro-openings such that the band or the single particle wide line are one particle of the predetermined diameter high. The apparatus of the invention controls the valves to cause opening or closure of the valves and when a valve is open a trail of evenly distributed loose particulate material is deposited, such that no further levelling of the deposited material is required, as is the case with some conventional powder deposition methods. The valves can be controlled to close or open independently to deposit the material as necessary on demand. For example, certain valves in the primary assembly can be turned off to leave blank regions which are subsequently filled using the material of the valves of the ancillary assembly. The apparatus of the present invention may be provided with a matrix of valves having different lengths of the dispensing openings. The advantages provided by the apparatus of the present inventions are numerous. For example, multiple materials can be simultaneously printed on each layer allowing numerous materials and properties to be integrated into individual printed articles. The apparatus provides for increased precision and accuracy of 3D printing because individual material particles can be manipulated, allowing article to be printed to tighter tolerances. The apparatus provides for increased material deposition speed due to multiple powder dispensing nozzles, thereby reducing build time. The apparatus and method of the present invention allow complex shapes to be printed without specially constructed support structures as with some other 3D printing methods, such as, for example, Fused Deposition Modelling, because unsintered material in any given layer provides support for the material deposited in the subsequent layer and loose unsintered material can be easily removed from the finished article. Thus, finished article can be generated without the need for secondary operations, such as cutting off support structures. Geometry and scale of the finished article is not limited by the constraints of other methods. In the apparatus and method of the present invention, multiple materials are simultaneously integrated into one sintered 3D printed article and this allows articles from many fields of technology to be produced. For example, N-type or P-type silicon powders can be sintered directly onto other materials allowing transistors and other electronic components to be integrated into individual parts. Conductive copper tracks can be sintered directly onto other materials, similar to commonly used Printed Circuit Boards (PCB), but non-conductive substrate can now be any material than can be sintered, conductive tracks and other features common to PCBs can take advantage of the third dimension. This opens up new possibilities regarding compact or solid electronic circuit boards, something previously impossible via traditional methods like acid etching. Hybrid materials can be printed; composites with directional strength, isotropic or orthotropic properties can be engineered into three dimensional designs. New alloys, new types of alloys, new types of carbon fibre composites, plastic composites or hybrid materials like ‘cermets’ can be engineered with precise properties. Multiple materials being simultaneously sintered to form a single or multiple individual components allow features inherent in certain materials like the elasticity of rubber or the rigidity and strength of nylon to be integrated to create ‘living hinges’ or combining different metals, such as, for example, steel and copper, to print bimetallic strips. By combining flexible rubber and elastomers with rigid plastics, combinations of flexibility can be engineered into any single object. For example, a box with rigid walls but flexible soft edges could be printed as a single component, additionally it could have an rigid door on top with a flexible rubber hinge integrated into the article.

Furthermore, Selective Laser Sintering uses a laser to heat powder particles to sintering temperature. Sometimes, though not entirely necessary but certainly advantageous, the build volume is pre-heated via heating elements provided in the build plate and surrounding walls. This pre-heating brings the temperature of the powder to just under the temperature required for sintering (usually by around 20 degrees or so), so that less energy is required by the laser to thermally sinter the powder. This improves build speed as less time is required by the laser to pass over each point. It also improves the structural accuracy and material performance of the final article because the powder volume does not have as steep a temperature gradient across it as it would have without pre-heating. Without pre-heating, the temperature would decrease greatly the greater the distance from the laser. This causes thermal stresses (sometimes called residual stresses) and can cause mechanical warping of the article being printed. It is usually a small amount of warping, but on larger parts it can be quite noticeable. Pre-heating is a method to try and reduce the temperature gradient. It is not perfect as the ratio of surface area to volume is large and there is always a face open upwards to the air in the build through which heat is lost. The advantage of the present invention is as follows. When the particulate material is stored in the dispenser unit awaiting to be deposited on the build plate, its volume is relatively small compared to the volume of material deposited on the build plate. This volume can be relatively easily heated by a heating element, such as, for example, a thermocouple, provided within the dispenser unit. Thus, when the material is deposited it is already pre-heated. Thus, by breaking up a larger volume into a number of smaller volumes, the effective surface area to volume ratio is technically improved and, accordingly, it is far more efficient to heat the material within the dispensing unit prior to depositing the material. Such an arrangement ensures that when the material is deposited on the build surface it merely needs “topping-up” from heating elements in the build plate or the surrounding walls to match the heat escaping from the open face of the deposited layer of material. This ensures, firstly, that the temperature gradient is smaller and more controllable and therefore residual stresses and warping are reduced, and, secondly, that energy is more efficiently used to pre-heat the powder.

The particle size quoted for a supply of the particulate material, such as powder, usually refers to the maximum particle diameter. For example, a batch of 100 micron (0.1 mm) powder will contain any particles under 100 microns (0.1 mm) in diameter but none greater than 100 microns (0.1 mm). Commonly used powders in Selective Laser Sintering that are suitable for use with the present invention are 100 micron (0.1 mm) powders, 200 micron (0.2 mm) powders, 50 micron (0.05 mm) powders and 20 micron (0.02 mm) powders. These sizes are usually dictated by the preferred layer thickness of any object being built. The process by which powders of certain sizes are made may not be not entirely perfect therefore occasionally some particle sizes will be greater than the quoted maximum diameter and it is within reason that a negligible portion of a volume of 100 micron (0.1 mm) powder may in fact be 250 microns (0.25 mm). It is up to the quality control of supplier to determine the accuracy of the quoted size. Therefore many suppliers state the quality of their powders using a percentage, for example, a batch of 100 micron (0.1 mm) powder guarantees that at least 90% of the volume of powder is below 100 microns (0.1 mm) in diameter. Some suppliers even state the minimum powder diameters as a percentage as well, such as in a batch of 100 micron (0.1 mm) powders, no more than 2% of the powder will be smaller than 30 microns (0.03 mm) in diameter. However, it is the maximum diameter specified on the batch that is used when adjusting the size of the nozzle of the 3D printer of the present invention.

In the present invention, particles of a range of diameters will actually contribute to the material density of the finished article, as smaller particles of powder will fill any gaps that exist when closely packing similar size particles, but the different diameters will all be equal or less than the specified maximum particle diameter. The size of the through passage of the nozzle of the 3D printer of the invention will ensure that a volume of particulate material no greater than the largest particle diameter (such as, for example, 100 microns or 0.1 mm) is allowed to pass through the nozzle. This may mean a single particle with 100 micron (0.1 mm) diameter or the equivalent volume of smaller powders such as 4 particles with 50 micron (0.05 mm) diameter. The end result will still be that the deposited layer of particulate material will be of uniform thickness (such as, for example, 100 microns or 0.1 mm thick).

Different versions of powder dispensing units may be made bespoke for different maximum sizes of particulate material, such as 500 microns (0.5 mm) for faster building or 20 microns (0.02 mm) for greater detail and accuracy. These different dispensing units are preferably easily interchangeable within the 3D printer of the invention, allowing a user to select particle sizes and layer thicknesses depending on the desired speed or detail of their printing.

The nozzle of the dispensing unit should not get clogged if an odd oversized particle tries to enter it. Due to its greater diameter the particle will be unable to fit into the through passage of the nozzle. Since no force other than gravity pushes it down, when the valve of the dispensing unit closes again the oversized particle will simply be pushed away from the entrance to the through passage. However, while the through passage remains open, the oversized particle will prevent smaller particles from entering the through passage and this may affect the quality of the finished article. To address this issue, each layer can be scanned to detect gaps in the deposited material and the 3D printer of the invention can be allowed to pass over the empty region and fill it.

A filter can be provided in the delivery arrangement or in the storage vessel to filter out oversized particles prior to dispensing the particulate material into the through passage of the nozzle. For example, a sheet filter (for example, a sheet of thin metal uniformly sized holes) may be positioned in the delivery arrangement or in the storage vessel. Any oversized particles will be unable to pass through the filter and remain above the filter to be brushed off. This ensures only particles of diameter equal or less the maximum specified diameter can enter the dispensing units. However, filters are also not perfect, quality affects their performance and many filters use the same specifications as powder when quoting performance, such as for example a guarantee to remove 95% of particles greater than the maximum specified diameter. Other filters use what is called an Absolute Micron Rating, which can guarantee filtering accuracy to 99%. For these reasons, in the present invention, the through passage itself may be considered as a filter.

As particulate material is reused and recycled in the 3D printer, its particles can eventually lose its roundness, sometimes they can flatten, due to thermal and/or mechanical stress, which render them no longer fit for use. In this case a filter can prove useful as a means of ensuring that recycled powder is not contaminated by damaged powder. Alternatively, a limited number of times, such as for example, ten times, of reusing the powder can be specified and adhered to.

Another solution to oversized particles is providing a nozzle in which the through passage can be increased and decreased in width or, as the case may be, length to suit specified particle sizes. The adjustable nozzle can be provided either on its own or as an auxiliary nozzle to the non-adjustable nozzle and can be operated by a separate actuator. This makes interchanging nozzles unnecessary and therefore makes selecting powder sizes and therefore layer thicknesses more convenient.

According to a fifth aspect of the present invention, there is provided a three dimensional printing apparatus comprising:
one or more dispensing units for dispensing particulate material;
an enclosure for containing the material dispensed by the one or more dispensing units;
wherein the enclosure includes one or more heating elements for heating the material contained in the enclosure to a first predetermined temperature.

Preferably, the apparatus comprises at least two dispensing units, of which a first dispensing unit is a primary dispensing unit for dispensing first particulate material and the second dispensing unit is an ancillary dispensing unit for dispensing second particulate material.

Preferably, the first predetermined temperature is a sintering temperature of the first particulate material. Preferably, the first particulate material has a melting point lower than that of the second particulate material. Accordingly, upon being heated by the heating element to the sintering temperature, the first material becomes sintered into a finished article whereas the second material, which may also be referred to as a refractory material, a filler material or a bulk material, remains unchanged. Since the second material retains its particulate form, the finished article can be simply withdrawn from the mass of the second material upon sintering. A refractory material is any material with a melting point higher than the material to be melted or sintered. Typically, a refractory material is the material used as a mould for casting. The second material may be selected from, for example, sand, ceramic powder, metal powder, plastic powder, as long as the second material has a higher sintering point that the first material. If sintering plastic, such as PLA, the second material can be silica sand or another plastic, such as nylon or ABS. If sintering metals, such as for example, steel or aluminium, refractory metals, such as for example, molybdenum or refractory ceramics, such as for example, alumina can be used as the second material. For sintering ceramics, very high temperatures are required, therefore a very high temperature refractory material, such as for example graphite, can be used.

The enclosure is comprises build chamber having a build plate and walls surrounding the build plate. The build plate preferably includes a build surface on which the material is being deposited. One or more of the heating elements may be provided in the walls. The build plate may also include one or more of the heating elements. The enclosure may be surrounded by thermal insulation to minimise heat loss and maximise the heat energy stored in the material being deposited.

The one or more heating elements are preferably arranged to pre-heat the material being deposited in the enclosure as well as to bring the temperature of the material to the first predetermined temperature.

Preferably, the one or more heating elements are arranged to heat the entire volume of the material that has been deposited in the enclosure. Thus, intermediate steps of sintering layer by layer are avoided.

Preferably, the one or more dispensing units are in accordance with the first aspect of the invention.

In one arrangement, the apparatus comprises one or more assemblies in accordance with the second aspect of the invention.

The first particulate material may comprise one or more sub-types. The sub-types of the first material may be the same or different type of material. The sub-types of the first material may be the same colour or different colours. The sub-types of the first material may have the same or different fineness.

The apparatus may include a third dispensing unit for dispensing third particulate material between the first and second materials. The third material may be, for example, but not limited thereto, a water dissolvable plastic or a wax based particulate material. After sintering, a layer of the second material may become adhered to outer surfaces the finished article formed from the first material. Certain types of second material, such as for example, sand, can be easily removed by, for example, flushing the article with water or other suitable fluid. Where this is not possible, the provision of the layer of third material prevents contamination of the finished article. Alternatively, the third material can be used to create a deliberate coating on the finished article.

According to a sixth aspect of the present invention, there is provided a method of forming a three dimensional object, the method comprising the steps of:
providing a three dimensional printing apparatus in accordance with the fifth aspect of the invention;
dispensing particulate material into the enclosure of the apparatus;
heating the material contained in the enclosure to a first predetermined temperature by the one or more heating elements of the apparatus thereby obtaining a three dimensional article.

Preferably, the method includes dispensing a first particulate material and a second particulate material into the enclosure, wherein the first predetermined temperature is a sintering temperature of the first particulate material and wherein the first particulate material has a melting point lower than that of the second particulate material.

Preferably, the method includes heating the first material by the heating element to the first predetermined temperature so that the first material becomes sintered into a finished article whereas the second material remains unchanged.

Preferably, the method includes using the heating elements to pre-heat the material being deposited in the enclosure as well as to bring the temperature of the material to the first predetermined temperature.

Preferably, the method includes depositing all the particulate material required to form an article into the enclosure and heating the entire volume of the material that has been deposited in the enclosure. Thus, intermediate steps of sintering layer by layer are avoided.

Preferably, the method includes using one or more dispensing units in accordance with the first aspect of the invention.

Preferably, the method includes using one or more assemblies in accordance with the second aspect of the invention.

The principal advantage of such an apparatus and method is that the action of having a laser selectively sinter a shape in each layer is no longer necessary. The layers are built up continuously one after the other with no sintering step in between. Once the layers have been completed, the entire build volume is then heated at once by the heating elements in the build volume walls. For example, by depositing ceramic powders as the bulk powder and a metal powder as the base powder to be sintered, the temperature is raised in the entire build volume in one final step to the sintering temperature of the metal, fusing the metal into the finished product and leaving the ceramic powder un-sintered and therefore ready to be reused. There are a number of advantages of removing the need for the laser. The laser sintering step usually takes up between 50% to 80% of the total build time, thus the build time can be vastly reduced; and by removing the laser from the machine, the most expensive and inefficient component is removed. Lasers are usually only around 10% efficient. While heating elements are also relatively inefficient, as a method of heating they are much more efficient than a laser. By removing the laser and replacing it with a heating element, the energy efficiency of the machine is improved. The laser can also take up a considerable portion of the total component cost of any SLS machine. A laser equivalent of a 500 W heating element can cost a thousand times more than the heating element, which is why many current SLS machines are forced to use cheaper low-wattage lasers to remain affordable. Accordingly, removing the laser considerably reduces the cost and complexity of the machine. Another advantage is that since that the bulk filler material is not intended to be sintered at all, it can be selected of the readily available and relatively inexpensive materials, such as for example, silica sand. Plastic powders for sintering are expensive and require a large bulk purchase in order to fill the build volume of current SLS machines. By purchasing only the amount of powder required to create a 3D article, powder is saved from being used as a filler material.

All essential, preferred or optional features or steps of one of the first, second, third, fourth, fifth or sixth aspects of the invention can be provided in conjunction with the features of the other of the first, second, third, fourth, fifth or sixth aspects of the invention, and vice versa, as appropriate.

### BRIEF DESCRIPTION OF THE DRAWINGS

Embodiments of the present invention are described hereinafter with reference to the accompanying drawings in which:

FIG. 1 is a cross-sectional side view of a material dispensing unit in accordance with the invention showing a valve of the dispensing unit in a closed position; and a close-up view of the valve;

FIG. 2 is a cross-sectional side view of the dispensing unit of FIG. 1 showing the valve of the dispensing unit in an open position; and a close-up view of the valve;

FIG. 3 is a quarter-sectional perspective view of a dispensing unit similar to that of FIG. 2 showing the valve of the dispensing unit in an open position and a line of material particles being deposited by the dispensing unit; and a close-up view of the valve;

FIG. 4 is a quarter-sectional perspective view of a dispensing unit similar to that of FIG. 2 showing the valve of the dispensing unit in an open position and a band of material particles being deposited by the dispensing unit; and a close-up view of the valve;

FIGS. 5, 6 and 7 are, respectively, a front view, a bottom view and a perspective view of a primary assembly of dispensing units of FIG. 1;

FIG. 8 is a partial perspective view of the assembly of FIGS. 5 to 7;

FIG. 9 is a partial cross-sectional end view of the assembly of FIGS. 5 to 7;

FIGS. 10, 11 and 12 are perspective views showing variations of a through channel in a valve body of the valve of the dispensing unit;

FIGS. 13, 14, 15 and 16 are, respectively, a perspective view, a front view, a bottom view and an enlarged partial bottom views of an ancillary assembly of dispensing units of FIG. 1;

FIG. 17 is a perspective view of a housing of the primary assembly of FIGS. 5, 6 and 7;

FIG. 18 is a transparent perspective view of the housing of FIG. 17;

FIG. 19 is a perspective view of a housing of the ancillary assembly of FIGS. 13, 14, 15 and 16;

FIG. 20 is a transparent perspective view of the housing of FIG. 19;

FIGS. 21 and 22 are, respectively, a perspective view and a plan view of a 3D printing apparatus in accordance with the invention, prior to printing a 3D article;

FIGS. 23 and 24 are, respectively, a perspective view and a front cross-sectional view of a 3D printing apparatus in accordance with the invention, after printing a 3D article;

FIG. 25 is a front cross-sectional view of another embodiment of a 3D printing apparatus in accordance with the invention;

FIG. 26 is a front cross-sectional view of the embodiment of 3D printing apparatus of FIG. 25 but in more detail; and

FIG. 27 is a perspective part (quarter) cross-sectional view of the embodiment of 3D printing apparatus of FIG. 26.

### DETAILED DESCRIPTION OF THE INVENTION

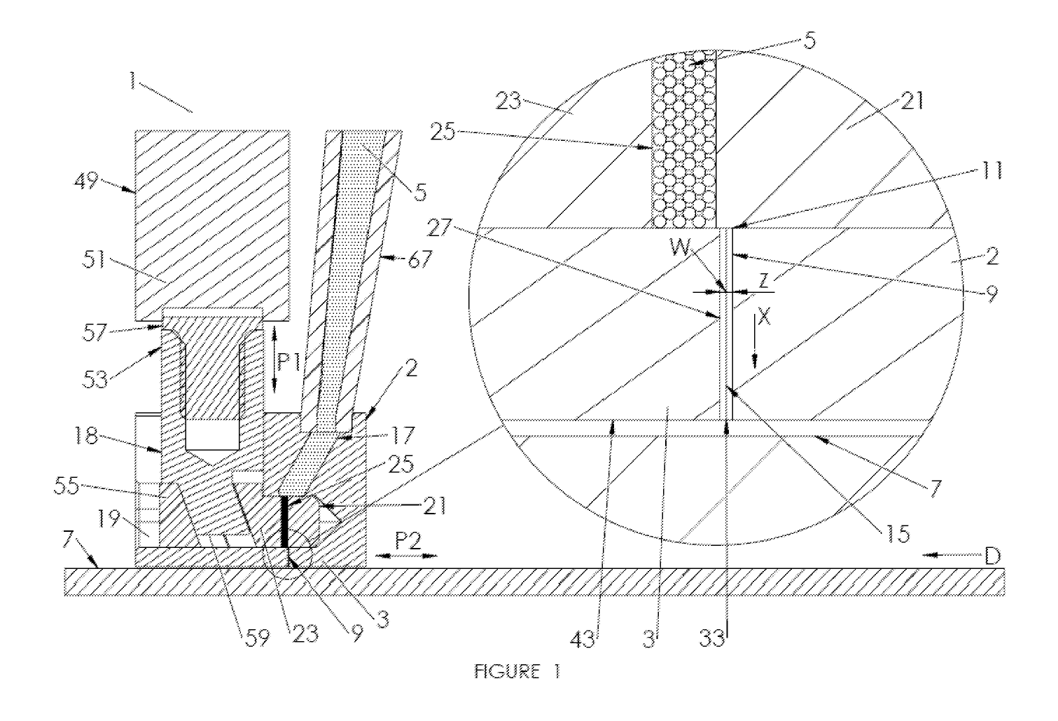

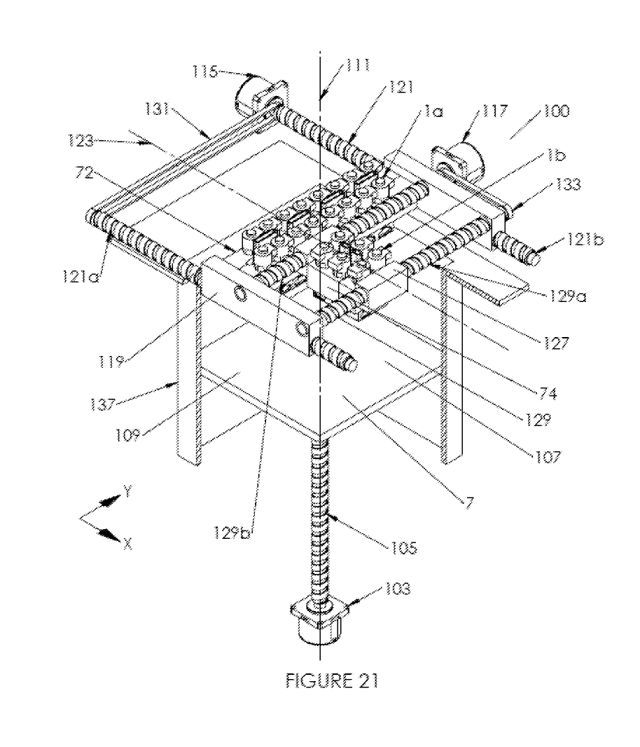

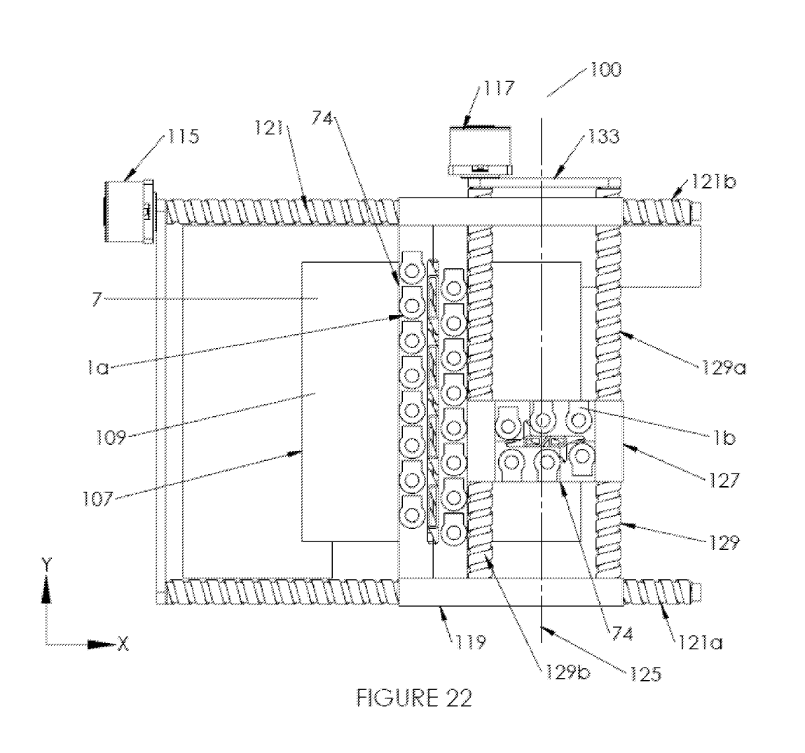

Referring to FIGS. 1 to 25, a three dimensional (3D) printing apparatus for forming three dimensional objects, a material dispensing unit therefor and a corresponding method of three dimensional printing will now be jointly described. The material dispensing unit of the invention is indicated generally using reference numerals 1 and 10 in the Figures. The 3D printing apparatus of the invention is indicated generally by reference numerals 100 and 200 in the Figures.

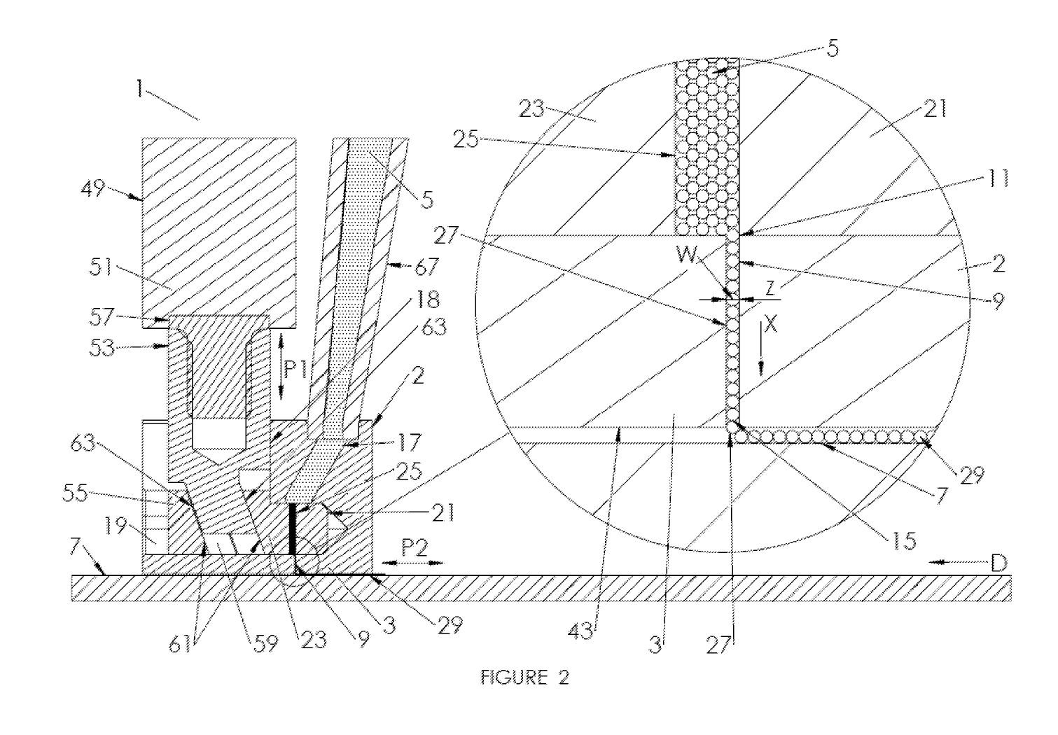

Referring initially to FIGS. 1 to 4, the material dispensing unit 1 for the three dimensional printing apparatus 100 comprises a housing 2 incorporating a nozzle 3 for depositing particulate material 5 on a build surface 7. It will be appreciated that in the present specification, for brevity, the term “build surface”, unless otherwise specified, includes an upper surface of a newly created layer onto which a subsequent layer is to be deposited as well as an upper surface of a build plate (to be described below) of the three dimensional printing apparatus. Typically, the upper surface of the build plate serves as a build surface for a first layer of the article to be printed. The nozzle 3 defines a through passage 9 for the material 5 and has an inlet end 11 for receiving the material 5 and an outlet end 15 for dispensing the material 5. The housing 2 incorporates a delivery arrangement provided in the form of a delivery duct 17 for delivering the material 5 into the through passage 9. The housing 2 also defines a cavity 19 for accommodating a valve 21 provided between the delivery duct 17 and the through passage 9 for controlling flow of the material 5 between the delivery duct 17 and the through passage 9. The valve 21 is operable between open and closed positions, wherein, in the closed position (FIG. 1), flow of the material 5 into the through passage 9 is blocked and, in the open position (FIGS. 2, 3 and 4), flow of the material 5 into the through passage 9 is allowed. The valve comprises a body 23 movable relative to the through passage 9 of the nozzle 3 between a first position (FIG. 1) in which the body 23 blocks the through passage 9 and the valve 21 is closed and a second position (FIGS. 2, 3 and 4) in which the through passage 9 is unblocked and the valve 21 is open. The body 23 comprises a through channel 25, wherein in the open position of the valve 21, the through channel 25 is in alignment with the through passage 9 of the nozzle 3 and with the delivery duct 17, and in the closed position of the valve 21, the through channel 25 is out of alignment with the through passage 9 of the nozzle 3 such that the body 23 blocks the through passage 9.

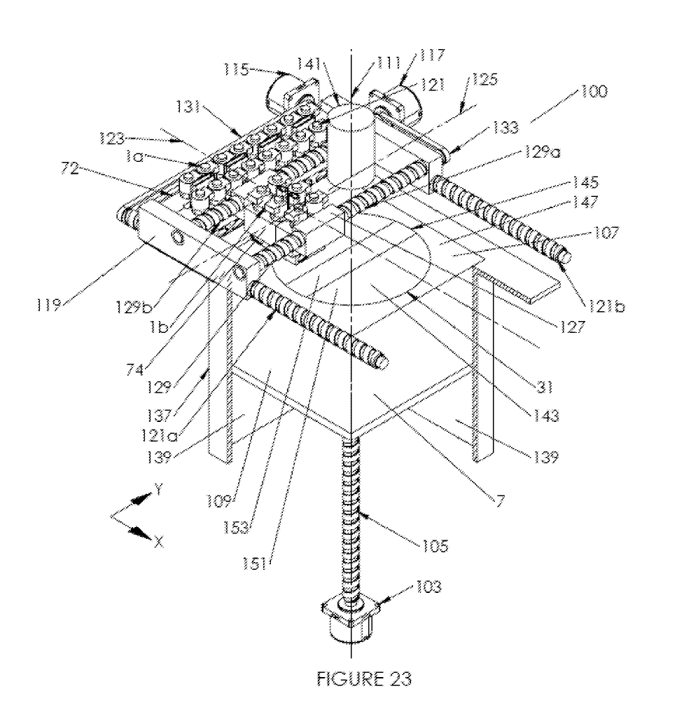

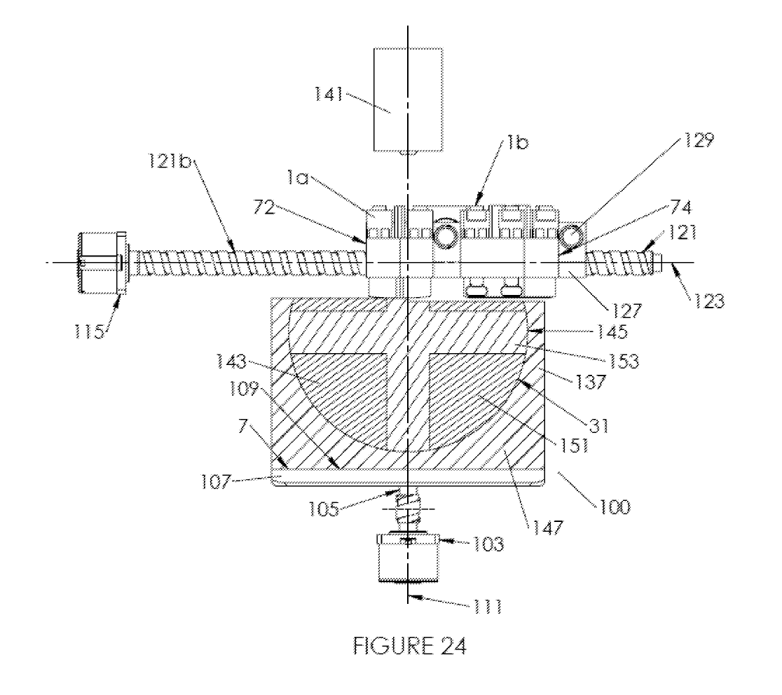

The through passage 9 has a longitudinal axis 33 (FIG. 1) extending between the inlet end 11 and the outlet end 13 substantially in the direction X (FIGS. 1 and 2) of flow of the material 5 through the passage 9. The through passage 9 has a width W in a cross section Z (FIGS. 1 to 4) substantially perpendicular to the longitudinal axis 33. In the presently described embodiment, the width W is sufficient to allow only a single particle 27 of a predetermined diameter of the particulate material 5 to pass through the cross section Z widthwise at a time. Accordingly, only one particle 27 of the predetermined diameter of the particulate material 5 is allowed to exit the through passage 9 widthwise and be deposited on the build surface 7 at a time. This allows a one particle high trail 29 of particles 27 of the predetermined diameter to be deposited on the build surface 7 during relative movement of the dispensing unit 1 across the build surface 7 with the valve 21 open. This in turn increases accuracy of a finished printed 3D article 31 (FIGS. 23 and 24). The speed of relative movement of the dispensing unit 1 across the build surface 7 is selected taking into account the predetermined diameter of the particles 27 so that the particles of the trail 29 are deposited on the build surface 7 adjacent to each other and, in some instances, in abutment with each other. Other widths W may be selected however, as appropriate.

Preferably, the predetermined diameter is the maximum particle diameter specified for a given batch of the particulate material.

In the presently described embodiment, the width W of the through passage 9 between the inlet and outlet ends 11, 13 in any given cross section Z substantially perpendicular to the direction X is constant. It will be appreciated, however, that the width W can vary along the direction of flow of the material through the passage 9 between the inlet and outlet ends 11, 13 as long as there is at least one cross section Z substantially perpendicular to the direction of flow of the material through the passage 9 whose width W is sufficient to allow only a single particle 27 of the predetermined diameter of the particulate material 5 to pass through the cross section Z widthwise at a time. In the presently described embodiment, the width W is provided by the cross sectional dimension of the through passage 9 itself. In other instances, the width W may be provided differently, for example, by obstructing the through passage 9 by another object, such as, for example, but not limited thereto, by a relevant portion of the valve 21.

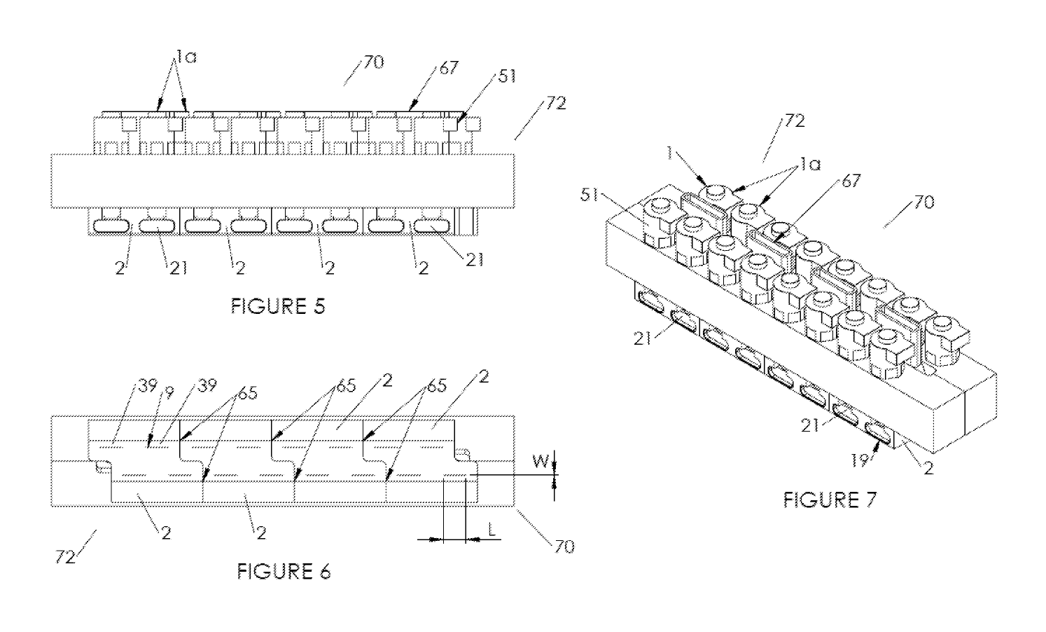

The through passage 9 has a length L (not visible in FIGS. 1 to 4, but shown in FIGS. 6, 15 and 18) in the cross section Z of the through passage 9 substantially perpendicular to the direction of flow of the material through the passage 9. The length L extends substantially perpendicular to the width W.

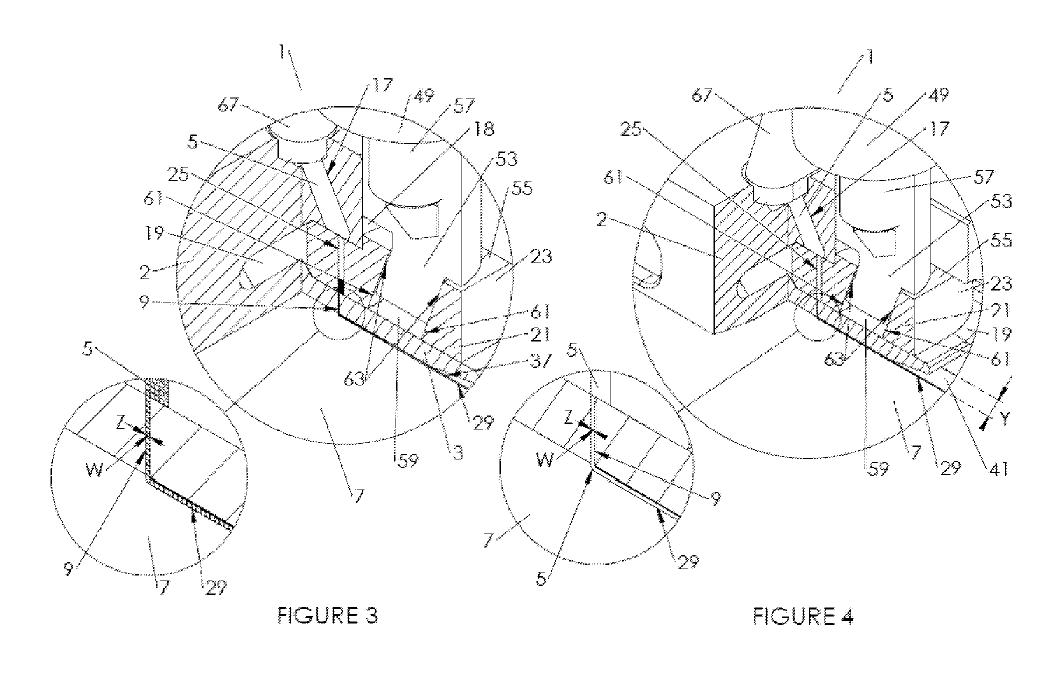

In the variation shown in FIG. 3, the length L is sufficient to allow only a single particle 27 of the predetermined diameter of the particulate material 5 to pass through the cross section Z lengthwise at a time. In other words, the cross section Z of the through passage 9 takes the form of an aperture 35 (see FIG. 15) having a width W and a length L, in other words, a diameter, sufficient to allow only a single particle 27 of the predetermined diameter of the particulate material 5 to pass through the cross section Z at a time. In this variation, the trail 29 of particles 27 deposited on the build surface 7 during relative movement of the dispensing unit 1 across the build surface 7, with the valve 21 open, takes the form of a line 37 (see FIG. 3) one particle 27 high and one particle 27 wide. In one particular variation, the aperture may be 0.1 mm in diameter.

In the variation shown in FIG. 4, the length L is sufficient to allow a predetermined number of particles 27 of the predetermined diameter of the particulate material 5 to pass through the cross section Z lengthwise at a time. In other words, the cross section Z of the through passage 9 takes the form of a slit 39 (see FIG. 15) having a width W sufficient to allow only a single particle 27 of the predetermined diameter of the particulate material 5 to pass through the cross section Z widthwise at a time and a length L sufficient to allow a predetermined number of particles 27 of the predetermined diameter of the particulate material 5 to pass through the cross section Z lengthwise at a time. In this variation, the trail 29 of particles 27 deposited on the build surface 7 during relative movement of the dispensing unit 1 across the build surface 7, with the valve 21 open, takes the form of a band 41 (see FIG. 4) one particle 27 high and the predetermined number of particles 27 wide in the direction Y across the band 41. In one particular variation, the slit 39 may be 0.1 mm wide and 4 mm long.

In use, the dispensing unit 1 is positioned in the three dimensional printing apparatus 100 such that during deposition of the particulate material 5 from the nozzle 3, the width W of the cross section Z of the through passage 9 is substantially parallel to the direction D of relative movement of the dispensing unit 1 across the build surface 7 and the length L of the cross section Z of the through passage 9 is substantially perpendicular to the direction of relative movement of the dispensing unit 1 across the build surface 7 in a plane substantially parallel to the build surface 7.

The nozzle 3 includes a planar surface 43 (FIGS. 1 and 2) surrounding the outlet opening 13 of the through passage 9 and lying a plane substantially perpendicular to the direction of flow of the material through the passage 9. The provision of the planar surface 43 helps to ensure that a one particle high layer of particles 27 is deposited on the build surface 7 and to hold down the already deposited particles 27.

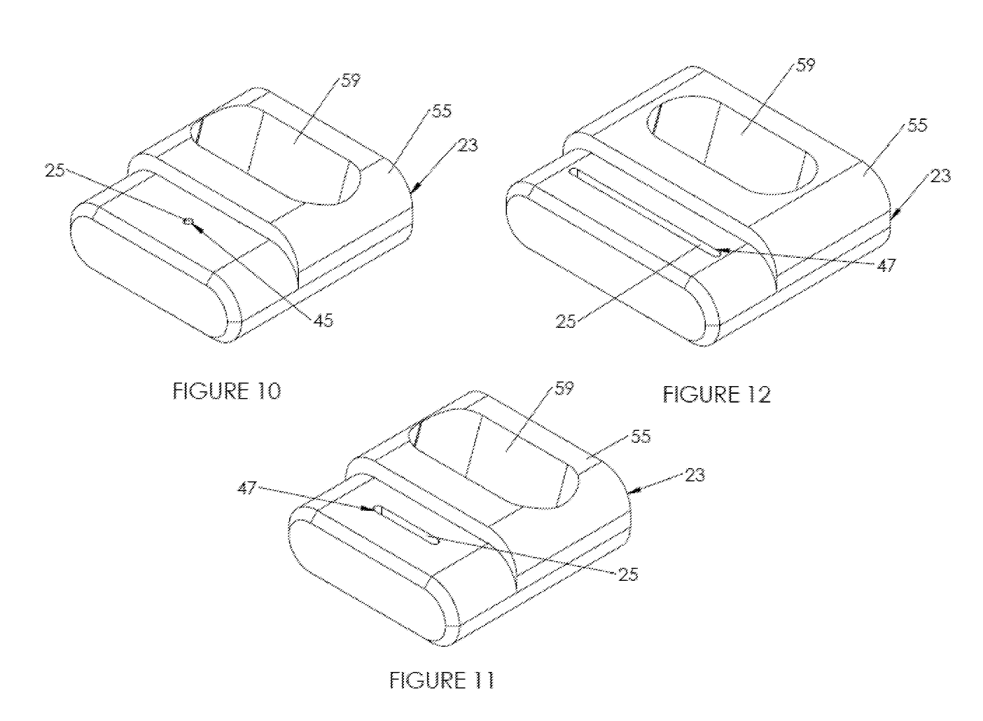

As shown in FIGS. 10 to 12, the through channel 25 of the valve body 23 may be shaped to conform to the shape of the through passage 9 of the nozzle 3. For example, if the through passage 9 takes the form of an aperture 35, the through channel 25 may also be provided as an aperture 45 (FIG. 10). If the through passage 9 takes the form of a slit 39, the through channel 25 may also be provided as a slit 47 (FIGS. 11 and 12).

The dispensing unit 1 comprises a controllable actuator arrangement 49, hereinafter referred to as actuator 49 for brevity, adapted for actuating the valve 21 to open or close. The actuator is located in a seat 18 provided in the housing 2. The actuator 49 is controlled by a control unit (not shown) of the 3D printing apparatus 100. The actuator 49 is adapted to move the valve body 23 between the first and second positions thereby opening and closing the through passage 9 as will be described in more detail below. The actuator 49 comprises a drive unit 51 for providing motive force for moving the valve 21. The drive unit 51 may be provided, for example, in the form of a stepper motor. An example of a suitable stepper motor is Haydon Kerk™ L15000 but other suitable models will be apparent to a person skilled in the art. It will be appreciated that the drive unit 51 may also be provided in any suitable form apparent to a person skilled in the art, such as for example, a different type of motor, a piezoelectric transducer, a hydraulic or pneumatic cylinder or other suitable means. The control unit is preferably an electronic control unit, preferably, a programmable electronic control unit.

The actuator 49 further comprises a cam pair comprising a cam member provided in the form of a piston rod 53 and a follower member 55 defined by a portion of the valve body 23. The piston rod 53 is moved by the drive unit 51 and is linked to the drive unit 51 by an actuator rod 57. The follower member 55 is integrally formed with the valve body 23 to move the valve body 23 to open and close the through channel 9 and the piston rod 53 is coupled with the follower member 55, such that movement of the piston rod 53 is translated into the movement of the follower member 55 and that of the valve body 21. The piston rod 53 is preferably arranged to move in the dispensing unit 1 along a first path P1. The follower member 55 moves the valve body 21 along a second path P2 for opening and closing the through channel 9. The piston rod 53 is coupled with the follower member 55 such that movement of the piston rod 53 along the first path P1 is translated into the movement of the follower member 55 and that of the valve body 21 along the second path P2. In the presently described embodiment, the first and second paths P1, P2 are provided perpendicular to each other. A bore 59 is defined in the follower member 55 for receiving the piston rod 53. The bore 59 has internal walls 61 bevelled in relation to each of the first and second paths P1, P2 and the piston rod 53 has complementary bevelled surfaces 63 in engagement with the bevelled walls 61 such that during movement of the piston rod 53 to and fro along the first path P1, force is applied to the bevelled walls 61 of the bore 59 to move the follower member 55 respectively to and fro along the second path P2. The cam pair has a predetermined translation ratio, i.e. the correlation of the distance travelled by the piston rod 53 along the first path P1 and the distance travelled by the follower member 55 along the second path P2 as a result. The predetermined ratio is selected such that for a given distance travelled by the piston rod 53 the follower member 55 travels a known smaller distance. Such an arrangement provides for a greater precision of the movement of the follower member 55 and as a result, that of the valve body 23. For example, if the ratio of the cam pair is 5:1, for any 5 given units of distance travelled by the piston rod 53 the follower member 55 travels 1 unit of distance. Other suitable ratios may be selected as necessary. Other variations of the cam member 53 and the follower member 55 will be apparent to a person skilled in the art.

It will be appreciated that the present invention is not limited to a particular type the actuator 49 and other types of actuator 49 will be apparent to a person skilled in the art. For example, but not limited thereto, the actuator 49 may be provided by a gear box, a worm box, a gear and a plank or another suitable mechanical or electromechanical actuation mechanism.

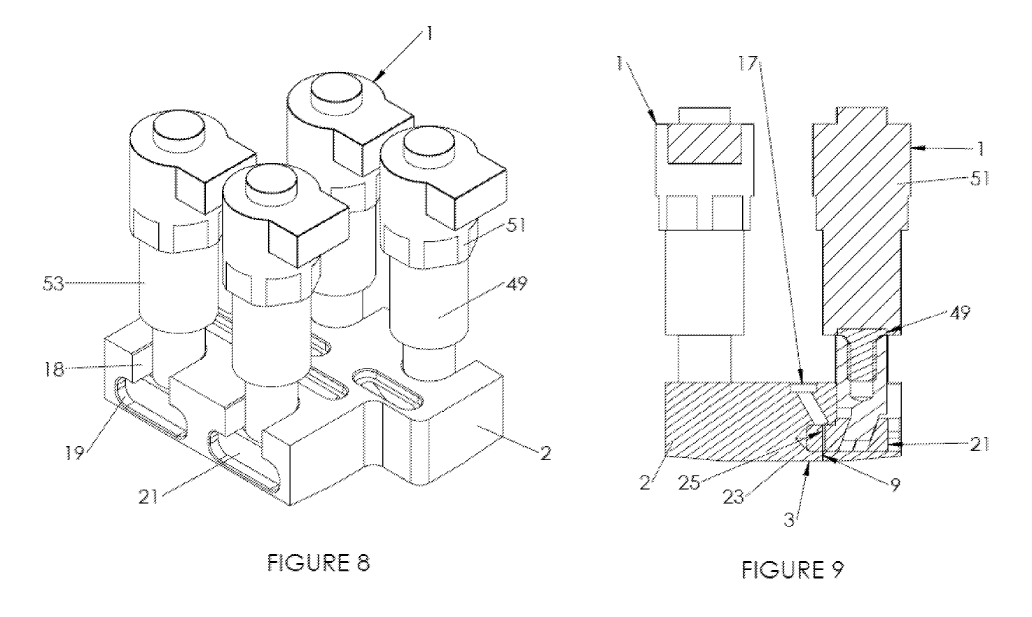

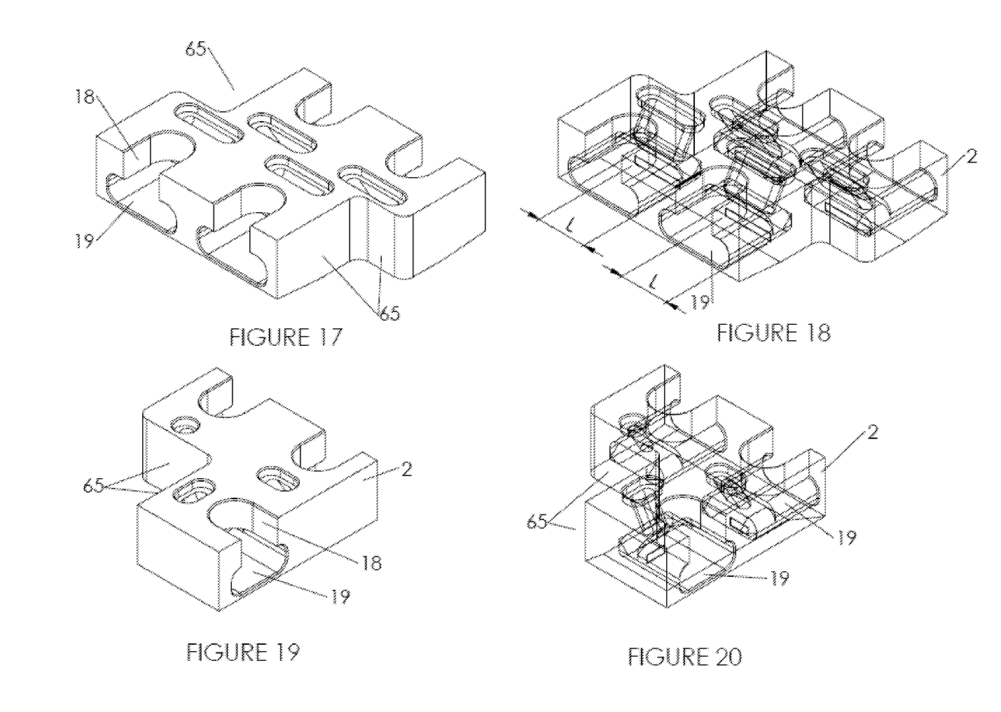

As shown in FIGS. 17 to 20, the housing 2 comprises one or more interlocking members or portions 65 for being connected with one or more housings 2 of further such dispensing units 1 in order to form an assembly comprising a plurality of dispensing units 1 as will be described below. Alternatively or additionally, as shown in FIGS. 8, 9 and 13, 14, the housing 2 may incorporate a plurality of nozzles 3, a plurality of cavities 19 for accommodating respective valves 21 and a plurality of seats 18 for mounting respective actuators 49.

The delivery duct 17 is arranged in communication with a storage vessel provided in the form of a generally upright chute 67 for containing the particulate material 5 and feeding the particulate material into the delivery duct 17. The upright chute 67 is located above the delivery duct 17 for gravity feeding the delivery duct 17.

Referring to FIGS. 5 to 7 and 13 to 16, in the presently described embodiment, a plurality of material dispensing units 1 form an assembly, indicated generally by reference numeral 70, wherein the dispensing units 1 are arranged in an array. The dispensing units 1 are connected in the assembly via the interlocking members 65 of respective housings 2. In such an assembly, individual chutes 67 may be provided for each delivery duct 17. Alternatively, as shown in FIGS. 5, 7 and 13, 14 one chute 67 may be arranged to feed a number of delivery ducts 17.

As shown in FIGS. 5 to 7, there is provided a first assembly, hereinafter referred to as the primary assembly 72 for brevity, comprising a plurality of primary dispensing units 1a arranged to form an array and adapted for dispensing first particulate material (not shown). The first particulate material may comprise one or more sub-types of the first material.

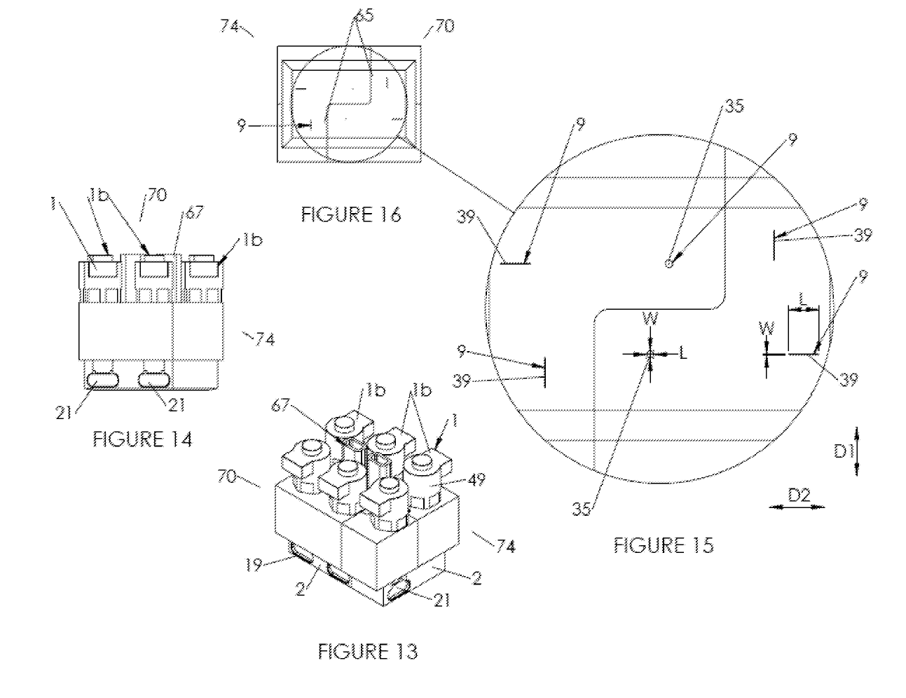

As shown in FIGS. 13 to 16, there is provided a second assembly, hereinafter referred to as the ancillary assembly 74 for brevity, comprising a plurality of ancillary dispensing units 1b arranged to form an array and adapted for dispensing second particulate material (not shown). The second particulate material may comprise one or more sub-types of the second material.

The first and second materials may be the same or different type of material. The first and second materials may be the same colour or different colours. The first and second materials may have the same or different fineness. In the presently described embodiment, the first particulate material is coarser than the second particulate material.

In the primary assembly 72, the primary dispensing units 1a have the through passages 9 that are provided as slits 39 having a width W sufficient to allow only a single particle 27 of the predetermined diameter of the particulate material to pass through the cross section Z (see FIG. 1) widthwise at a time and a length L sufficient to allow a predetermined number of particles 27 of the predetermined diameter of the particulate material to pass through the cross section Z lengthwise at a time. The slits 39 are uniformly oriented in the primary assembly 72. The slits 39 are positioned such that an uninterrupted band (not shown) of material is deposited on the build surface 7 from the slits 39 when the respective valves 21 are open. The slits 39 may be positioned in a single line. However, as shown in FIG. 6, to ensure that there are no gaps between individual bands of material deposited between two adjacent slits 39, the slits 39 are preferably positioned along at least two parallel lines in which the slits 39 are arranged in a staggered manner.

In the ancillary assembly 74, some of the ancillary dispensing units 1b have through passages 9 that are provided as slits 39 having a width W sufficient to allow only a single particle 27 of the predetermined diameter of the particulate material to pass through the cross section Z (see FIG. 1) widthwise at a time and a length L sufficient to allow a predetermined number of particles 27 of the predetermined diameter of the particulate material to pass through the cross section Z lengthwise at a time. As shown in FIGS. 15, 16, the assembly 74 includes four slits 39 which are positioned rotated relative to each other by 90 degrees in a plane substantially parallel to the build surface 7. The rotation between said slits allows two of the four slits 39 to deposit respective bands of material when the ancillary assembly 74 is moved in a first direction D1 substantially perpendicular to each of the two slits 39; and the other two of the four slits 39 can deposit respective bands of material when the ancillary assembly 74 is moved in a second direction D2 substantially perpendicular to each of the said other two slits 39 and to the first direction D1. Some of the ancillary dispensing units 1b have the through passages 9 that are provided as apertures 35 having cross sections Z with a width W and a length L sufficient to allow only a single particle 27 of the predetermined diameter of the particulate material to pass through the cross section Z of the aperture 35 at a time.

Referring to FIGS. 21 to 24, the three dimensional printing apparatus 100 in accordance with the presently described embodiment of the invention comprises a primary assembly 72 of dispensing units 1a for dispensing first material and an ancillary assembly 74 of dispensing units 1b for dispensing second material. The apparatus 100 includes a build plate 107 which has an upper surface 109 serving as a build surface 7 for a first layer of the article 31 to be printed. The first layer deposited on the upper surface 109 of the build plate 107 is typically not sintered so that the printed article 31 remains unattached to the build plate 107 for ease of removal. The assemblies 72, 74 are movably arranged in the apparatus 100 to move relative to the build surface 7 in a plane substantially parallel to the build surface 7 as will be described below in more detail. Although not shown in the drawings, the apparatus 100 comprises a control arrangement configured for controlling the relative movement of the assemblies 72, 74 across the build surface 7. The control arrangement is also configured for controlling the speed of relative movement of the assemblies 72, 74 across the build surface 7 taking into account the predetermined diameter of the particles of the first and second materials so that the particles are deposited on the build surface 7 in a one particle high trail adjacent to each other and, in some instances, in abutment with each other.

A motor 103 is provided for effecting movement of the build plate 107 along an axis 111 substantially perpendicular to the build surface 7 (and which is typically the vertical axis 111) to provide spacing between the build surface 7 and the outlet ends 13 of the dispensing units 1a, 1b. A guide structure is provided in the form of a lead screw 105 for guiding and supporting the build plate 107 during its movement along the axis 111 (typically to raise and/or lower the build platform along the vertical axis 111). The apparatus 100 also includes a control mechanism (not shown) configured for controlling the motor 103 so as to provide a predetermined spacing between the build surface 7 and the outlet ends 13 of the dispensing units 1a, 1b. Preferably, the control mechanism is configured for controlling the motor 103 so that the distance between the outlet ends 13 and the build surface 7 is sufficient to allow only a single particle 27 of the predetermined diameter of the particulate material to be accommodated between each outlet opening 13 and the build surface 7 in the direction of the axis 111. This ensures that a one particle high layer is deposited on the build surface 7 and that the already deposited particles are held in place. Once a new layer has been created and sintered, the dispensing units 1a, 1b are spaced from the new layer by the same distance to allow another new layer to be created.

Further respective main motor 115 and ancillary motor 117 are provided for moving and positioning the assemblies 72, 74 in a plane XY substantially parallel to the build surface 7. The primary assembly 72 is mounted on a main carrier frame 119 which in turn is mounted on a main guide structure 121 and is moved by the main motor 115 along a first axis 123 substantially parallel to the build surface 7. The ancillary assembly 74 is mounted on an ancillary carrier frame 127 which in turn is mounted on an ancillary guide structure 129 and is moved by the ancillary motor 117 along a second axis 125 which is perpendicular to the first axis 123 in a plane substantially parallel to the build surface 7. The ancillary guide structure 129 is in turn mounted on the main carrier frame 119 so that the ancillary assembly 74 can be moved along both first and second axes 123, 125. Generally, the ancillary guide structure 129 is preferably arranged to give the ancillary carrier frame 127 more degrees of freedom to move across the build surface 7 than has the main carrier frame 119. In the presently described embodiment, the main guide structure 121 is provided by a pair of lead screws 121a, 121b laterally spaced apart relative to the first axis 123 and the ancillary guide structure 129 is provided by a pair of lead screws 129a, 129b laterally spaced apart relative to the second axis 125. It will be appreciated that the guide structures 121, 129 may be provided in any suitable form, as will be apparent to a person skilled in the art. Each of the main guide structure 121 and the ancillary guide structure 129 includes a synchronising mechanism, in the presently described embodiment provided in the form of respective drive belts 131, 133 coupled between the respective lead screws 121a, 121b; 129a, 129b, to synchronise rotation of the lead screws 121a, 121b; 129a, 129b. The main carrier frame 119 and the ancillary carrier frame 127 may be sliding carrier frames.

The apparatus 100 includes a build chamber 137 for containing the deposited particulate material 5. The build chamber 137 is defined by walls 139 surrounding the build plate 107 whereas the build plate 107 functions as a base of the build chamber 137. The walls 139 of the build chamber 137 may be transparent.

The apparatus 100 is preferably configured for sintering only predetermined regions in any given layer. The apparatus 100 comprises a laser sintering unit 141 provided above the build surface 7 and configured for selective sintering of the loose particulate material 5 in any given layer deposited by the dispensing units 1a, 1b to create solid regions in the layer and to bond the solid regions to the previously created layer. An electronic control system (not shown) is provided configured for controlling the operation of the laser sintering unit 141 to sinter predetermined regions 143, 145 in the layer of the deposited material. Any unsintered material 147 along with the sintered regions, becomes a support structure for the subsequent layer. The process is repeated until a solid 3D printed article 31 is obtained which can be picked up out of the unsintered material 147. Any unused loose material, including the unsintered material 147 and leftover material in the dispensing units 1a, can be re-used for the next print. The material used in the unsintered regions is preferably the material from the dispensing units 1b of the main assembly 72, i.e. the first material.

The control unit for controlling the actuators 49, is configured for controlling the actuators 49 of the main assembly 72 to selectively open and close of the valves 21 of the dispensing units 1a of the main assembly 72 in order to deposit the first material onto the predetermined regions 143 on the build surface 7. This allows the predetermined regions 147 in a layer to be left blank. The blank predetermined regions 147 can then be filled using the second material of the dispensing units 1b of the ancillary assembly 74. For this purpose, the control unit for controlling the actuators 49, is configured for controlling the actuators 49 of the ancillary assembly 74 to selectively open and close of the valves 21 of the dispensing units 1b of the ancillary assembly 74 in order to deposit the second material onto the predetermined regions 147 on the build surface 7 that have been left blank. Thus, a three dimensional article 31 can be created which includes parts 151, 153 composed from different materials. The control unit is preferably configured for controlling the actuator 49 in each dispensing unit 1a, 1b independently.

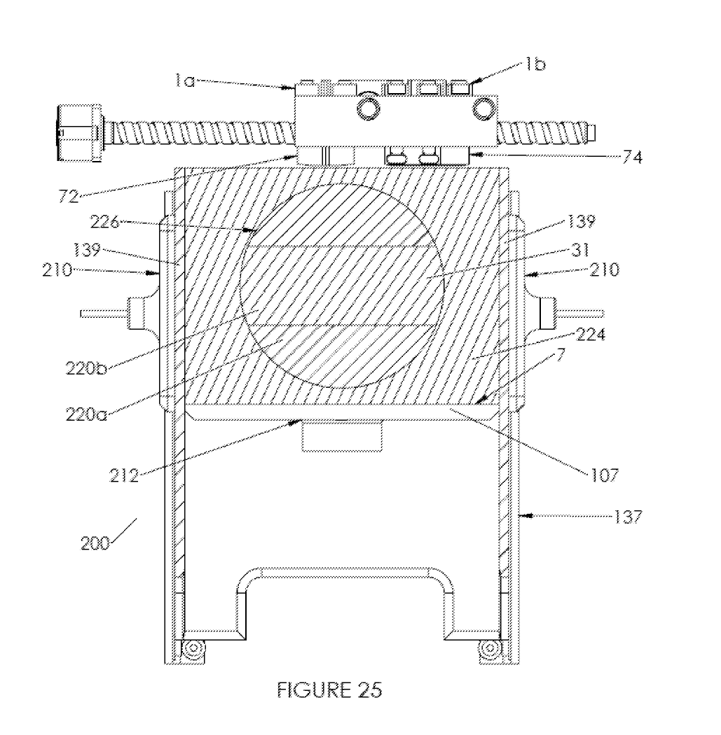

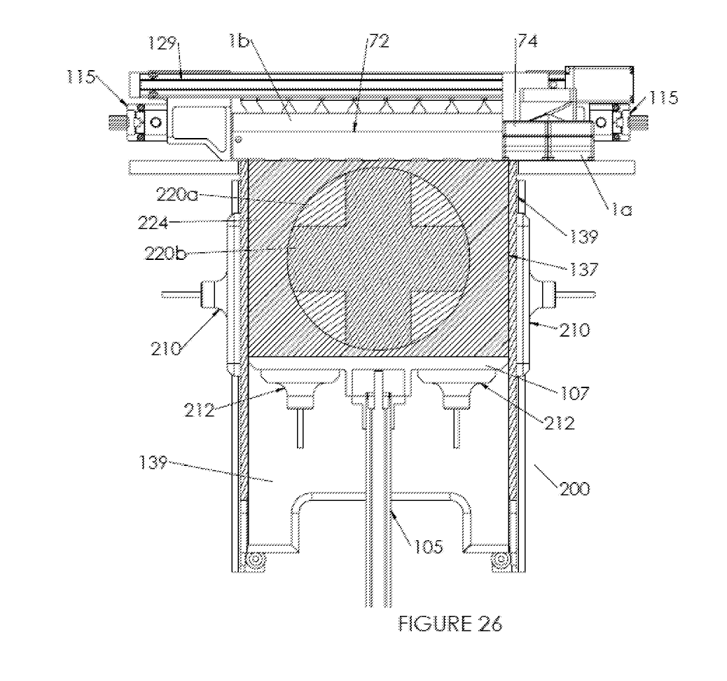

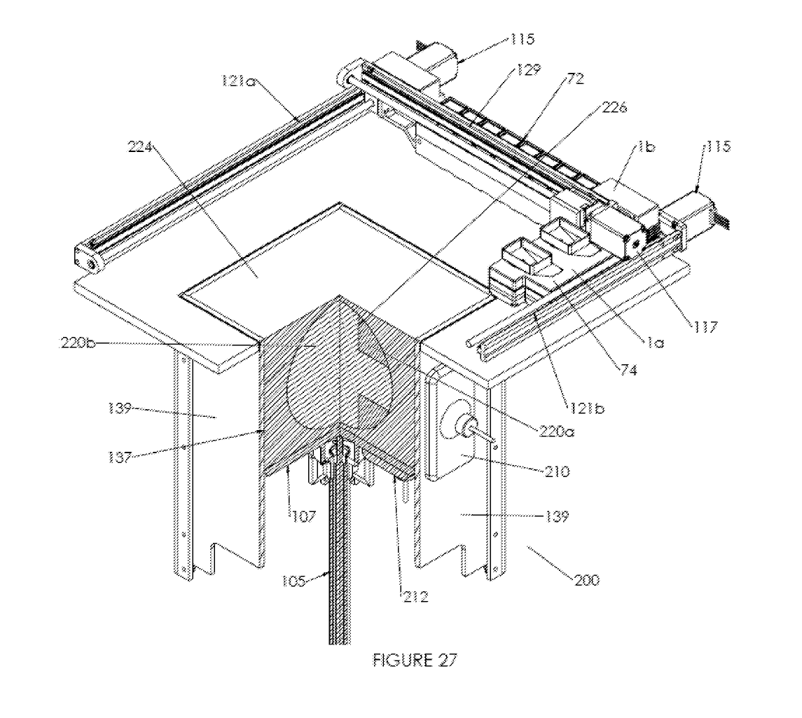

Referring to FIGS. 25 to 27, a further embodiment of the three dimensional printing apparatus of the invention is indicated generally by reference numeral 200. The apparatus 200 in the presently described embodiment is similar to the apparatus 100 described above in that it employs similar dispensing units 1a, 1b as those used in the apparatus 100 and particulate material is dispensed in a manner similar to that described above. Therefore, for brevity, the apparatus 200 will be described below in terms of its difference from the apparatus 100 and like reference numerals have used in FIGS. 25 to 27 to denote features of the apparatus 200 common with those of the apparatus 100.

The apparatus 200 comprises a primary assembly 72 comprising a plurality of primary dispensing units 1a for dispensing first particulate material 220a, 220b (which may be multiple different types of powder from respective multiple different primary dispensing units 1a simultaneously into the gaps left by the bulk or ancillary dispensing units 1b) and a second assembly 74 comprising a plurality of ancillary dispensing units 1b for dispensing second particulate material 224 (which is likely to be the bulk of the material and moreover is preferably whichever powder material that will take up the most volume in the build chamber 137). The apparatus 200 comprises an enclosure provided in the form of a build chamber 137 for containing the material dispensed by the dispensing units 1a, 1b. The build chamber 137 has a build plate 107 and walls 139 surrounding the build plate 107. The build plate 107 includes a build surface 7 on which the first layer of the material 220a, 220b, 224 is deposited, with each respective subsequent planar layer of the material 220a, 220b, 224 being deposited in turn on top of the immediately previous layer as in the apparatus 100.

The apparatus 200 differs from the apparatus 100 in that instead of using a laser sintering unit to heat the required material 220a, 220b in the layer just laid (prior to the next layer being laid), the apparatus 200 comprises heating elements 210, 212 arranged in the build chamber 137 for heating the material 220a, 220b contained in the build chamber 137 to a first predetermined temperature which is a sintering temperature of the first particulate material 220a, 220b. The heating elements 210 are provided within or are arranged in close conductive contact with the walls 139 and the heating element 212 is provided within or are arranged in close conductive contact with the build plate 107, such that when the heating elements 210, 212 are heated, that heat is firstly conducted to the walls 139 and build plate 107 and then conducted on to the various powder/particulate materials 220a, 220b, 224 being used therein. Accordingly, the walls 139 and build plate 107 act as heat conductors to transfer thermal energy from the heating elements 210, 212 to the various powder/particulate materials 220a, 220b, 224 contained within the walls 139 and build plate 107. Importantly, the walls 139 and build plate 107 are formed of a heat conductive material comprising a higher melting and/or sintering temperature than all of the various powder/particulate materials 220a, 220b, 224 being used therein. It should be noted that the heating elements 210, 212 can also be initially used as pre-heaters to reduce warping and thermal stresses in the powders/particulate materials 220a, 220b, 224. However, as hereinbefore described, during the final stage the heating elements 210, 212 will raise the temperature within the build volume defined by the inner surfaces of the walls 139 and build plate 107 to just above the melting and/or sintering temperature of the powders 220a, 220b being formed into the finished product but below the temperature of the ‘refractory’ powder 224. This allows the powders 220a, 220b to be melted and/or sintered into a finished object without the need for the laser system used in the first embodiment of the three dimensional printing apparatus 100 which utilised selective laser sintering & selective laser melting. It should be noted that the heating elements 210, 212 can be simple metal or ceramic heating elements 210, 212 that use thermal conduction to transfer heat through the build chamber walls 139 and/or the build plate 107 into the build volume and such an arrangement is suitable for non-conductive powders 220a, 220b, 224. like plastics or ceramics. Alternatively, for certain metal powders, which are electrical conductors, the use of induction heat mechanisms can be utilised. Further alternatively, any other suitable form of heating can be used to raise the temperature of the build volume in a controlled manner.

Although not shown in the drawings, the build chamber 137 may be surrounded by thermal insulation to minimise heat loss and maximise the heat energy stored in the material being deposited. The first particulate material 220a, 220b has a melting point lower than that of the second particulate material 224. Upon being heated by the heating elements 210, 212 and therefore the walls 139 and build plate 107 to or just above the sintering temperature of the first material 220a, 220b, the first material 220a, 220b becomes sintered into a finished article 31 whereas the second material 224, which may also be referred to as a refractory (or crucible) material, a filler material or a bulk material, remains unchanged. Since the second material 224 retains its particulate form, the finished article 31 can be simply withdrawn from the mass of the second material 224 upon conclusion of the sintering process.

The heating elements 210, 212 are preferably arranged to pre-heat the material 220a, 220b, 224 in the build chamber 137 (in order to reduce the time taken for the overall sintering process) as well as to bring the temperature of the material 220a, 220b, 224 to the first predetermined temperature. In use, all the material 220a, 220b required to form an article 31 is deposited into the build chamber 137 and the heating elements 210, 212 are arranged to heat the entire volume of the material 220a, 220b, 224 that has been deposited in the build chamber 137. Thus, intermediate steps of sintering layer by layer are avoided and this provides the great advantage for embodiments of apparatus 200 that the time taken to produce the finished article 31 will be greatly reduced compared to the time taken for the finished article 31 produced by the first embodiment of apparatus 100.

The first particulate material 220a, 220b may comprise one or more sub-types. The sub-types of the first material 220a, 220b may be the same or different type of material, the same colour or different colours or may have the same or different fineness.

Although not shown in the drawings, the apparatus 200 may include a third dispensing unit for dispensing third particulate material 226 between the first material 220a, 220b and the second material 224. The third material may 226 be, for example, but not limited thereto, a water dissolvable plastic or a wax based particulate material. Accordingly, the second material 224 such as sand is used as the ‘refractory’ powder 224 and acts as a mould between which the ancillary powder 220 or powders 220a, 220b can be sintered and/or melted into finished parts or article 31. After sintering, a layer of the second material 224 may become adhered to outer surfaces of the finished article 31 formed from the first material 220a, 220b. Certain types of second material 224, such as for example, sand and which could be simple building sand (of approximately 80 to 100 micron size sand), can be easily removed by, for example, flushing the article with water or other suitable fluid.

Where this is not possible, the provision of the layer of third material 226 prevents contamination of the finished article 31. Alternatively, the third material 226 can be used to create a deliberate coating on the finished article 31.

Modifications are possible within the scope of the invention as will be apparent to a person skilled in the art.

1. A material dispensing unit for a three dimensional printing apparatus, the material dispensing unit comprising:
a nozzle for depositing particulate material on a build surface;
the nozzle defining a through passage for said material, the through passage having an inlet end for receiving said material and an outlet end for dispensing said material;
a valve provided at least one of at, within or in fluid communication with the through passage for controlling flow of said material via the through passage, the valve being operable between open and closed positions, wherein, in the closed position, flow of said material into the through passage is blocked and, in the open position, flow of said material into the through passage is allowed,
wherein the dispensing unit comprises a controllable actuator arrangement adapted for actuating the valve to open or close;
wherein the actuator arrangement comprises a cam pair comprising a cam member and a follower member;
wherein the follower member is linked with the valve body to move the valve body to open and close the through channel and the cam member is coupled to the follower member, such that movement of the cam member is translated into the movement of the follower member and that of the valve body.

2. A material dispensing unit according to claim 1, wherein the through passage has a width in a cross section substantially perpendicular to the direction of flow of said material through said passage and said width is sufficient to allow only a single particle of a predetermined diameter of the particulate material to pass through the cross section widthwise at a time such that only one particle of the predetermined diameter of the particulate material is allowed to exit the through passage widthwise and be deposited on the build surface at a time.

3. A material dispensing unit according to claim 1, wherein the material in a new layer which has been deposited by the material dispensing unit is selectively sintered by a laser provided above the build surface in the three dimensional printing apparatus thereby creating solid regions in the layer and bonding the solid regions to the previously created layer and any unsintered material, along with the sintered regions, becomes a support structure for the subsequent layer and wherein the layers are sintered until a solid 3D printed article is obtained.

4. A material dispensing unit according to claim 1, wherein the upper surface of the build plate serves as a build surface for a first layer of the article to be printed.

5. A material dispensing unit according to claim 1, wherein the width of the through passage in a cross section substantially perpendicular to the direction of flow of said material through the passage is one of constant or varied along the through passage between the inlet and outlet ends as long as there is at least one cross section substantially perpendicular to the direction of flow of said material through the passage whose width is sufficient to allow only a single particle of a predetermined diameter of the particulate material to pass through the cross section widthwise at a time.

6. A material dispensing unit according to claim 1, wherein the through passage has a length in the cross section of the through passage substantially perpendicular to the direction of flow of said material through the passage, the length extending substantially perpendicular to the width.

7. A material dispensing unit according to claim 6, wherein the length is sufficient to allow only a single particle of a predetermined diameter of the particulate material to pass through the cross section lengthwise at a time such that the trail of particles deposited on the build surface during relative movement of the dispensing unit across the build surface, with the valve open, takes the form of a line one particle high and one particle wide.

8. A material dispensing unit according to claim 6, wherein the length is sufficient to allow a predetermined number of particles of a predetermined diameter of the particulate material to pass through the cross section lengthwise at a time such that the trail of particles deposited on the build surface during relative movement of the dispensing unit across the build surface, with the valve open, takes the form of a band one particle high and the predetermined number of particles wide in the direction across the band.

9. A material dispensing unit according to claim 1, wherein in use, the dispensing unit is positioned in the three dimensional printing apparatus such that during deposition of the particulate material from the nozzle of said dispensing unit, the width of the cross section of the through passage is substantially parallel to the direction of relative movement of the dispensing unit across the build surface and the length of the cross section of the through passage is substantially perpendicular to the direction of relative movement of the dispensing unit across the build surface in a plane substantially parallel to the build surface.

10. A material dispensing unit according to claim 1, wherein the nozzle includes a planar surface surrounding the outlet opening of the through passage and lying in a plane substantially perpendicular to the direction of flow of said material through the passage.

11. A material dispensing unit according to claim 1, wherein the valve comprises a body movable relative to the through passage of the nozzle between a first position in which the body blocks the through passage and the valve is closed and a second position in which the through passage is unblocked and the valve is open.

12. (canceled)

13. A material dispensing unit according to claim 1, wherein the actuator arrangement is controlled by a control unit.

14. A material dispensing unit according to claim 12, wherein the actuator arrangement is adapted for moving the valve body between the first and second positions thereby opening and closing the through passage.

15. A material dispensing unit according to claim 1, wherein the actuator arrangement comprises a drive unit for providing motive force for moving the valve.

16. A material dispensing unit according to claim 1, wherein the body comprises a through channel, wherein in the open position of the valve, the through channel is in alignment with the through passage of the nozzle, and in the closed position of the valve, the through channel is out of alignment with the through passage of the nozzle such that the body blocks the through passage.

17. (canceled)

18. A material dispensing unit according to claim 1, wherein the cam member is arranged to move in the dispensing unit along a first path and the follower member is linked with the valve body to move the valve body along a second path for opening and closing the through channel.

19. A material dispensing unit according to claim 1, wherein the follower member is formed integrally with the valve body and the cam member is coupled with the follower member such that movement of the cam member along the first path is translated into the movement of the follower member and that of the valve body along the second path.

20. A material dispensing unit according to claim 1, wherein the cam pair comprises a predetermined translation ratio which is the correlation of the distance travelled by the cam member and the distance travelled by the follower member as a result, wherein the predetermined ratio is selected such that for a given distance travelled by the cam member the follower member travels a known smaller distance.

21. A material dispensing unit according to claim 1, wherein the cam member comprises a piston rod and the follower member comprises a portion of the valve body and a bore is defined in the follower member for receiving the piston rod, wherein the bore has internal walls bevelled in relation to each of the first and second paths and the piston rod is in engagement with the bevelled walls such that during movement of the piston rod to and fro along the first path, force is applied to the bevelled walls of the bore to move the follower member respectively to and fro along the second path with the applicable translation ratio thereby moving the valve body between the open and closed positions.

22. A material dispensing unit according to claim 1, wherein the cam member is moved by the drive unit of the actuator arrangement.

23. A material dispensing unit according to claim 1, wherein the dispensing unit comprises a housing incorporating the nozzle, the housing also defining a cavity for accommodating the valve and a seat for mounting the actuator arrangement.

24. A material dispensing unit according to claim 1, wherein the dispensing unit comprises a delivery arrangement for delivering said material into the through passage and wherein the delivery arrangement is arranged in communication with a storage vessel for containing the particulate material and feeding the particulate material into the delivery arrangement.

25. A material dispensing unit according to claim 1, wherein a plurality of material dispensing units are arranged in an array to form an assembly of dispensing units.

26. A material dispensing unit according to claim 25, wherein there is provided a primary assembly comprising a plurality of primary dispensing units for a three dimensional printing apparatus, wherein the units are arranged to form an array and are adapted for dispensing first particulate material.

27. A material dispensing unit according to claim 26, wherein there is provided an ancillary assembly comprising a plurality of ancillary dispensing units for a three dimensional printing apparatus, wherein the units are arranged to form an array and are adapted for dispensing second particulate material.

28. A three dimensional printing apparatus comprising:
one or more dispensing units according to claim 1;
a build surface for supporting the material dispensed from the one or more dispensing units;
wherein the one or more dispensing units are movably arranged to move relative to the build surface in a plane substantially parallel to the build surface.

29. A three dimensional printing apparatus according to claim 28, wherein the apparatus comprises a control arrangement configured for controlling the relative movement of the one or more dispensing units across the build surface, wherein the control arrangement is configured for controlling the speed of relative movement of the one or more dispensing unit across the build surface taking into account the predetermined diameter of the particles of the particulate material so that the particles are deposited on the build surface in a one particle thick trail adjacent to each other and, in some instances, in abutment with each other.

30. A three dimensional printing apparatus according to claim 28, wherein the control unit for controlling the actuator arrangement of the or each dispensing unit is configured for controlling the actuator arrangement to selectively open and close the valve of the or each dispensing unit in order to deposit the particulate material onto predetermined regions of the build surface.

31. A three dimensional printing apparatus according to claim 28, wherein the control unit is configured for controlling the actuator arrangement to open and close the respective valve in each dispensing unit independently, such that a three dimensional article can be created which includes parts composed from different materials.

32. A method of forming a three dimensional object, the method comprising the steps of:
providing a three dimensional printing apparatus in accordance with claim 28; and
printing a three dimensional article using the three dimensional printing apparatus.

33. A method of forming a three dimensional object according to claim 32, wherein the method comprises the step of controlling the valve of the one or more dispensing units to open and close and in the open position of the valve allowing only a single particle of a predetermined diameter of the particulate material to pass through the cross section of the through passage of the nozzle of the one or more dispensing units widthwise at a time.

34. A method of forming a three dimensional object according to claim 32, wherein the method comprises the step of moving the one or more dispensing units relative to the build surface in plane substantially parallel to the build surface and depositing a one particle high trail of particulate material on the build surface.

35. A method of forming a three dimensional object according to claim 32, wherein the method further comprises the step of creating one particle high layer of particulate material of a plurality of trails of particles deposited on the build surface during relative movement of the one or more dispensing units across the build surface, each trail being laid in the form of a band one particle high and a predetermined number of particles wide in the direction across the band or a line one particle high and one particle wide.

36. A method of forming a three dimensional object according to 32, wherein the method comprises controlling the speed of relative movement of the dispensing unit across the build surface taking into account the predetermined diameter of the particles of the particulate material being deposited so that the particles are deposited on the build surface adjacent to each other.

37. A method of forming a three dimensional object according to claim 32, wherein the method includes controlling relative movement of the one or more dispensing units in relation to the build surface along an axis substantially perpendicular to the build surface so as to provide a predetermined spacing between the build surface and the outlet end of the through passage of nozzle of the dispensing unit.

38. A method of forming a three dimensional object according to claim 32, wherein the method includes controlling said relative movement so that a distance between said outlet end and the build surface is sufficient to allow only a single particle of a predetermined diameter of the particulate material to be accommodated between the outlet opening of the nozzle and the build surface in the direction substantially perpendicular to the build surface.

39. A method of forming a three dimensional object according to claim 32, wherein once a new layer has been created, the dispensing unit is spaced from the new layer by the same distance.

40. A method of forming a three dimensional object according to claim 32, wherein the build volume is pre-heated via heating elements provided in the build plate and surrounding walls to bring the temperature of the powder to just under the temperature required for sintering.

41. A three dimensional printing apparatus comprising:
at least two dispensing units, of which a first dispensing unit is a primary dispensing unit for dispensing first particulate material and the second dispensing unit is an ancillary dispensing unit for dispensing second particulate material;
an enclosure for containing the material dispensed by the one or more dispensing units;
wherein the enclosure includes one or more heating elements for heating the material contained in the enclosure to a first predetermined temperature;
wherein the one or more heating elements are arranged to heat the entire volume of the material that has been deposited in the enclosure such that intermediate steps of sintering layer by layer are avoided; and
wherein the first predetermined temperature is a sintering temperature of the first particulate material and wherein the first particulate material has a melting point lower than that of the second particulate material such that upon being heated by the heating element to the sintering temperature, the first material becomes sintered into a finished article whereas the second material remains unchanged.

42-44. (canceled)

45. A method of forming a three dimensional object, the method comprising the steps of:
providing a three dimensional printing apparatus in accordance with claim 41;
wherein the method includes dispensing a first particulate material and a second particulate material into the enclosure, wherein the first predetermined temperature is a sintering temperature of the first particulate material and wherein the first particulate material has a melting point lower than that of the second particulate material and the method further includes heating the first material by the heating element to the first predetermined temperature so that the first material becomes sintered into a finished article whereas the second material remains unchanged;
wherein the method includes depositing all the particulate material required to form an article into the enclosure and heating the entire volume of the material that has been deposited in the enclosure such that intermediate steps of sintering layer by layer are avoided.

46-47. (canceled)

48. A three dimensional object formed by operation of the material dispensing unit of claim 1.

49. A three dimensional object formed by operation of the three dimensional printing apparatus of claim 28.

50. A three dimensional object formed by following the steps of method claim 32.

51. A three dimensional object formed by operation of the three dimensional printing apparatus of claim 41.

52. A three dimensional object formed by following the steps of method claim 45.
